(19) United States
(12) Patent Application Publication
(10) Pub. No.: US 2017/0051857 A1
(43) Pub. Date: Feb. 23, 2017

(54) MULTI-CHANNEL ROTARY JOINT

(71) Applicant: Nippon Pillar Packing Co., Ltd., Osaka-shi, Osaka-fu (JP)

(72) Inventors: Hiroyuki SAKAKURA, Osaka-shi (JP); Megumi TANIGUCHI, Osaka-shi (JP); Mitsuharu OHGA, Osaka-shi (JP)

(73) Assignee: Nippon Pillar Packing Co., Ltd., Osaka-shi, Osaka-fu (JP)

(21) Appl. No.: 15/307,655

(22) PCT Filed: Feb. 19, 2016
(86) PCT No.: PCT/JP2016/054784

§ 371 Date: Oct. 28, 2016

(30) Foreign Application Priority Data
Mar. 9, 2015 (JP) 2015-045413
Mar. 9, 2015 (JP) 2015-045523
Mar. 9, 2015 (JP) 2015-046499

(51) Int. Cl. F16L 27/08; F16J 15/34

(52) U.S. Cl. CPC F16L 27/08; F16J 15/34

(57) ABSTRACT

A multi-channel rotary joint, wherein, between the opposed peripheral surfaces of a housing body (1) and a rotary shaft body (2) coupled thereto for free relative rotation, four or more mechanical seals (3) are provided that effect sealing using the relative rotational sliding contact action of opposed end faces (31a, 32a) of stationary sealing rings (32) provided on the housing body (1) and rotating sealing rings (31) provided on the rotary shaft body (2), and the joint has a single rotating sealing ring (31A) that does double duty as the rotating sealing rings (31, 31) for adjacent mechanical seals (3, 3). In this joint, coating layers (10a, 10a) made from a material with a higher heat transfer coefficient and hardness compared to the material of the double-duty rotating sealing ring (31A) are formed on both end faces (31a, 31a) of the rotating sealing ring (31A).

### TECHNICAL FIELD

The present invention relates to a multi-channel rotary joint that allows two or more fluids to flow between relatively rotating members in rotary devices used in the semiconductor field and the like (for example, in CMP (Chemical Mechanical Polishing) apparatuses, such as surface polishers for semiconductor wafers, etc.).

### BACKGROUND ART

Prior-art multi-channel rotary joint of this type is disclosed in Patent Document 1. In this well-known rotary joint (hereinafter referred to as a “conventional rotary joint”), between opposed peripheral surfaces of a tubular housing body and a rotary shaft body concentrically coupled thereto in a manner to make a relative rotation, four or more mechanical seals are provided. These mechanical seals are adapted to effect sealing using the relative rotational sliding contact action of the sealing end faces (i.e., opposed end faces) of stationary seal rings provided on the housing body and rotary seal rings provided on the rotary shaft body, and they are arranged in a columnar configuration in the direction of the rotational axis of such two bodies, thus forming multiple passage connection spaces sealed by adjacent mechanical seals. The two bodies (the tubular housing body and the rotary shaft body) are formed therein with fluid passages placed in communication with each other through the passage connection spaces. The joint thus structured is adapted to allow two or more types of fluid to flow between the two bodies through a series of multiple channels formed by connecting the two fluid passages through the passage connection spaces.

In this manner, in the conventional rotary joint, a single rotary seal ring, both end faces of which being sealing end faces, does double duty as a rotary seal ring for at least one mechanical seal and as a rotary seal ring for the mechanical seal adjacent thereto. Accordingly, as disclosed in Patent Document 2, the axial length (length in the direction of the rotational axis of the two bodies) of the rotary joint can be shortened to make it more compact, and, in addition, the configuration of the mechanical seals (and hence, the configuration of the rotary joint) can be simplified due to the reduced number of parts compared to multi-channel rotary joints in which the rotary seal rings of all the mechanical seals are independent members having only one of their end faces used as a sealing end face.

### PRIOR ART DOCUMENTS

### Patent Documents

Patent Document 1: Japanese Patent Application Laid-Open (Kokai) No. 2002-174379

Patent Document 2: Japanese Patent Application Laid-Open (Kokai) No. 2002-005380

### SUMMARY OF THE INVENTION

### Technical Problem

However, in the conventional rotary joint, both end faces of the above-described double-duty rotary seal ring (i.e., its two sealing end faces) generate heat as a result of the respective relative rotational sliding contact with the stationary seal rings, and this causes the rotary seal ring to be heated to a higher temperature than when only one of its end faces is used as a sealing end face. As a result, thermal strain is developed on the sealing end faces of the rotary seal ring, thus creating the risk of rendering a proper relative rotational sliding contact with the counterpart seal rings (stationary seal rings) impossible, of impeding the adequate display of sealing capabilities (hereinafter referred to as “mechanical sealing capabilities”) by the mechanical seals, and thus of allowing fluids to leak from the passage connection spaces.

In addition, in the conventional rotary joint, the amount of heat generated in the area of relative rotational sliding contact of one of the sealing end faces of the above-described double-duty rotary seal ring with a sealing end face of the stationary seal ring may differ from that generated in the area of relative rotational sliding contact of the other sealing end face of the rotary seal ring with another sealing end face of the stationary seal ring. For example, it can happen that the contact pressure of the two sealing end faces in one mechanical seal and the contact pressure of the two sealing end faces in another mechanical seal are different due to a pressure difference between the fluid flowing that is caused by the respective passage connection spaces sealed by the two mechanical seals, for which the rotary seal ring does double duty, or due to variation in the pressure of the fluids. When this happens, the amount of heat generated in the areas of relative rotational sliding contact with the two seal rings in the two mechanical seals will become different. In such a case, there is a risk that there could be a significant temperature difference between the two sealing end faces of the double-duty rotary seal ring and a significant thermal strain that adversely affects the mechanical sealing capabilities could develop in said sealing end faces.

It is an object of the present invention to solve the above-described problems arising from the structure that the rotary seal ring does double duty in adjacent mechanical seals and to provide a multi-channel rotary joint that allows adequate flow of two or more types of fluid without developing leaks.

### Solution to Problem

The present invention proposes a multi-channel rotary joint, in which,
between the opposed peripheral surfaces of a tubular housing body and a rotary shaft body coupled thereto in a manner of permitting relative rotation, four or more mechanical seals are provided
   which are adapted to effect sealing using relative rotational sliding contact action of sealing end faces that are opposed end faces of stationary seal rings provided on the housing body and rotary seal rings provided on the rotary shaft body, and
   which are arranged in a columnar configuration in the direction of the rotational axis of the two bodies,
thus forming multiple passage connection spaces sealed by adjacent mechanical seals;
the two bodies are formed therein with fluid passages placed in communication through the passage connection spaces; and
a single rotary seal ring, both end faces of which are sealing end faces, is provided so as to do double duty as a rotary seal ring for at least one mechanical seal and as a rotary seal ring for the mechanical seal adjacent thereto; and

wherein coating layers made from a material with a higher heat transfer coefficient and hardness compared to the material of the rotary seal ring are formed on both end faces of the double-duty rotary seal ring.

In a preferred embodiment of the present invention, coating layers made from a material with a higher heat transfer coefficient and hardness compared to the material of the rotary seal ring are formed continuously on both end faces and either of the inner and outer peripheral surfaces (inner peripheral surface or outer peripheral surface) of the double-duty rotary seal ring. In addition, it is preferable that a pair of oil seals are provided at the opposite sides of the mechanical seal group disposed in the columnar configuration in the direction of the rotational axis of the two bodies, so that a cooling fluid space is formed which is a space to which a cooling fluid is cyclically supplied and which is sealed by the two oil seals between the opposed peripheral surfaces of the two bodies. In this case, it is preferable that each oil seal be made up of rotary seal rings located at the ends of the seal ring group and annular sealing members of elastic material secured to the housing body and applying pressure to the outer peripheral surface of the rotary seal rings and that coating layers made from a material with a higher heat transfer coefficient and hardness compared to the material of the rotary seal ring be formed continuously on at least one of the outer peripheral surface and two end faces of the rotary seal rings forming part of the oil seal.

In addition, mechanical seals can be used instead of oil seals. In this case, it is preferable that a pair of mechanical seals intended for the cooling fluid space and having the same construction as the above-described mechanical seals be provided on both sides of the mechanical seal group disposed in a columnar configuration in the direction of the rotational axis of the two bodies, thus forming a cooling fluid space, which is a space to which a cooling fluid is cyclically supplied and which is sealed by the two mechanical seals intended for the cooling fluid space, between the opposed peripheral surfaces of the two bodies. In such a case, a single rotary seal ring, both end faces of which are sealing end faces, is preferably used as the rotary seal ring of a mechanical seal intended for the cooling fluid space and as the rotary seal ring of the mechanical seal adjacent thereto, and coating layers made from a material with a higher heat transfer coefficient and hardness than the material of the rotary seal rings are preferably formed on both end faces of said rotary seal rings. Furthermore, a single rotary seal ring, both end faces of which are sealing end faces, is preferably used as the rotary seal ring of a mechanical seal intended for the cooling fluid space and as the rotary seal ring of the mechanical seal adjacent thereto, and coating layers made from a material with a higher heat transfer coefficient and hardness higher than the material of the rotary seal rings are preferably formed continuously on both end faces and either of the inner and outer peripheral surfaces of the rotary seal ring. In addition, passages used for supplying and discharging a cooling fluid, through which a cooling fluid is cyclically supplied to the cooling fluid space, are preferably formed in the housing body, with the rotational axis of the two bodies preferably extending in the vertical direction.

In addition, the radial face width of the sealing end faces of each of the stationary seal rings that are in relative rotational sliding contact with the double-duty rotary seal ring is preferably smaller than the radial face width of the sealing end faces of said rotary seal ring. In addition, coating layers made from a material with a higher heat transfer coefficient and hardness compared to the material of the seal ring are preferably formed on the sealing end faces of all the seal rings, all the rotary seal rings, or all the stationary seal rings.

In addition, if the fluid flowing through a series of channels formed by connecting the fluid passages of the two bodies through the passage connection spaces is ultrapure or pure water, or a fluid averse to metal ion elution, then the above-described coating layers are continuously formed on the surfaces in contact with the fluid in the seal rings, including on the sealing end faces of the seal rings, while plastics are preferred for the surfaces or areas that are in contact with the fluid and are other than the seal rings and form the channels. In any case, the coating layers are preferably made from diamond.

### Advantageous Effects of the Invention

In the multi-channel rotary joint of the present invention, the sealing end faces, which are both end faces of a rotary seal ring performing double duty as adjacent mechanical seals (hereinafter referred to as a “double-duty rotary seal ring”), have formed thereon coating layers that are made from a material with a higher hardness compared to the material of the rotary seal ring. Accordingly, the amount of wear and heat generated in the areas of relative rotational sliding contact with the counterpart seal rings (stationary seal rings) on the two sealing end faces of the double-duty rotary seal ring can be reduced as much as possible. Moreover, since the coating layers are made from a material having a higher heat transfer coefficient compared to the material of the double-duty rotary seal ring, heat generated in the coating layers formed on the two sealing end faces of the double-duty rotary seal ring is dissipated as much as possible, and the double-duty rotary seal ring is not heated to elevated temperatures. As a result, no significant thermal strain that adversely affects the mechanical sealing capabilities is developed on the two sealing end faces of the double-duty rotary seal ring. Such effects are displayed in a particularly pronounced manner when the coating layers are formed from diamond.

Therefore, in accordance with the present invention, wear and heat generation in the area of relative rotational sliding contact of the double-duty rotary seal ring and stationary seal rings, as well as the development of thermal strain in the two sealing end faces of the double-duty rotary seal ring, are prevented as much as possible for an extended period of time. It is, compared to conventional rotary joints, thus possible to provide an eminently practical multi-channel rotary joint of superior durability and reliability.

In addition, in the multi-channel rotary joint of the present invention, coating layers made from a material with a higher heat transfer coefficient and hardness compared to the material of the double-duty rotary seal ring may be formed continuously on both end faces as well as on either of the inner and outer peripheral surfaces of the rotary seal ring. Accordingly, heat generated in the coating layers formed on the two sealing end faces of the double-duty rotary seal ring is mutually transferred through the coating layers formed on the outer peripheral surfaces or inner peripheral surfaces, so that the two sealing end faces of the double-duty rotary seal ring is brought to uniform temperature. As a result, there is no significant temperature difference occurs between the two sealing end faces of the double-duty rotary seal ring, and no significant thermal strain that adversely affects the mechanical sealing capabilities is developed on the two sealing end faces. Such effects are obtained in a particularly pronounced manner when the coating layers are formed from diamond.

Furthermore, in the multi-channel rotary joint of the present invention, in each oil seal, coating layers made from a material with a higher heat transfer coefficient and hardness compared to the material of the rotary seal rings may be formed on the outer peripheral surface of the rotary seal rings. Accordingly, the amount of wear and heat generated in the area of relative rotational sliding contact of the annular sealing members and rotary seal rings can be reduced to a minimum, and it is possible to ensure adequate oil sealing capabilities for the two oil seals for an extended period of time even if one or both oil seals are placed in a dry atmosphere. Furthermore, the coating layers are formed continuously on the end faces on the side opposite the sealing end faces (hereinafter referred to as “non-sealing end faces”) in the rotary seal rings, thus allowing the heat generated in the area of relative rotational sliding contact of the oil seal to be quickly transferred to the non-sealing end faces through the coating layers. Accordingly, the temperature difference between the two end faces, which are the sealing end faces of the rotary seal rings that generate heat as a result of the relative rotational sliding contact with the stationary seal rings, and the end faces on the opposite side (non-sealing end faces), is reduced as much as possible, thereby enabling maximum protection against the development of significant thermal strain that adversely affects the mechanical sealing capabilities of said sealing end faces. Such effects are displayed in a particularly pronounced manner when the coating layers are formed from diamond. Therefore, according to the present invention, it is possible to provide adequate oil sealing capabilities and mechanical sealing capabilities for an extended period of time and is also possible to provide an eminently practical rotary joint of superior durability and reliability compared to conventional rotary joints.

### BRIEF DESCRIPTION OF THE DRAWINGS

FIG. 1 is a cross-sectional view illustrating an example of the multi-channel rotary joint according to the present invention.

FIG. 2 is a cross-sectional view of the multi-channel rotary joint, in which the cross-section is taken at a location different from FIG. 1.

FIG. 3 is an enlarged detailed cross-sectional view illustrating an essential portion of FIG. 1.

FIG. 4 is an enlarged detailed cross-sectional view illustrating an essential portion of FIG. 1 different from FIG. 3.

FIG. 5 is a cross-sectional view of an essential portion corresponding to FIG. 3 that illustrates a variation of the multi-channel rotary joint of the present invention.

FIG. 6 is a cross-sectional view of an essential portion corresponding to FIG. 3 that illustrates another variation of the multi-channel rotary joint of the present invention.

FIG. 7 is a cross-sectional view corresponding to FIG. 1 that illustrates yet another variation of the multi-channel rotary joint of the present invention.

FIG. 8 is a cross-sectional view corresponding to FIG. 1 that illustrates yet another variation of the multi-channel rotary joint of the present invention.

FIG. 9 is a cross-sectional view corresponding to FIG. 1 that illustrates yet another variation of the multi-channel rotary joint of the present invention.

FIG. 10 is a cross-sectional view of an essential portion corresponding to FIG. 4 that illustrates yet another variation of the multi-channel rotary joint of the present invention.

FIG. 11 is a cross-sectional view of an essential portion corresponding to FIG. 4 that illustrates yet another variation of the multi-channel rotary joint of the present invention.

FIG. 12 is a cross-sectional view of an essential portion corresponding to FIG. 3 that illustrates yet another variation of the multi-channel rotary joint of the present invention.

FIG. 13 is a cross-sectional view of an essential portion corresponding to FIG. 3 that illustrates yet another variation of the multi-channel rotary joint of the present invention.

FIG. 14 is a cross-sectional view of an essential portion corresponding to FIG. 3 that illustrates yet another variation of the multi-channel rotary joint of the present invention.

FIG. 15 is a cross-sectional view of an essential portion corresponding to FIG. 3 that illustrates yet another variation of the multi-channel rotary joint of the present invention.

FIG. 16 is a cross-sectional view of an essential portion corresponding to FIG. 3 that illustrates yet another variation of the multi-channel rotary joint of the present invention.

FIG. 17 is a cross-sectional view of an essential portion corresponding to FIG. 3 that illustrates yet another variation of the multi-channel rotary joint of the present invention.

FIG. 18 is a cross-sectional view of an essential portion corresponding to FIG. 3 that illustrates yet another variation of the multi-channel rotary joint of the present invention.

FIG. 19 is a cross-sectional view corresponding to FIG. 1 that illustrates yet another variation of the multi-channel rotary joint of the present invention.

FIG. 20 is a cross-sectional view corresponding to FIG. 1 that illustrates yet another variation of the multi-channel rotary joint of the present invention.

### MODES FOR CARRYING OUT THE INVENTION

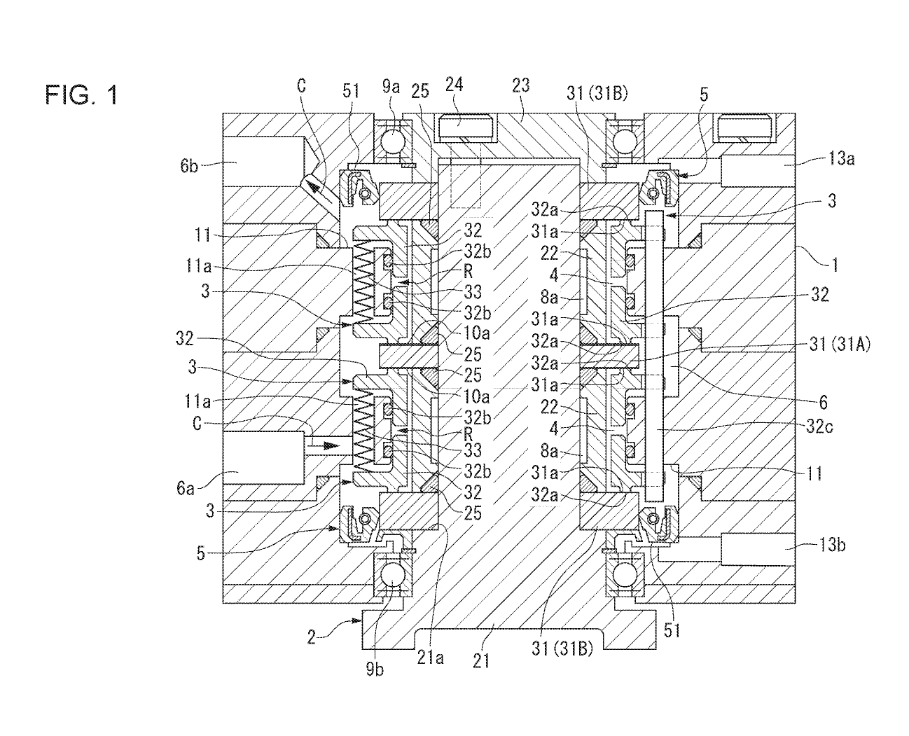

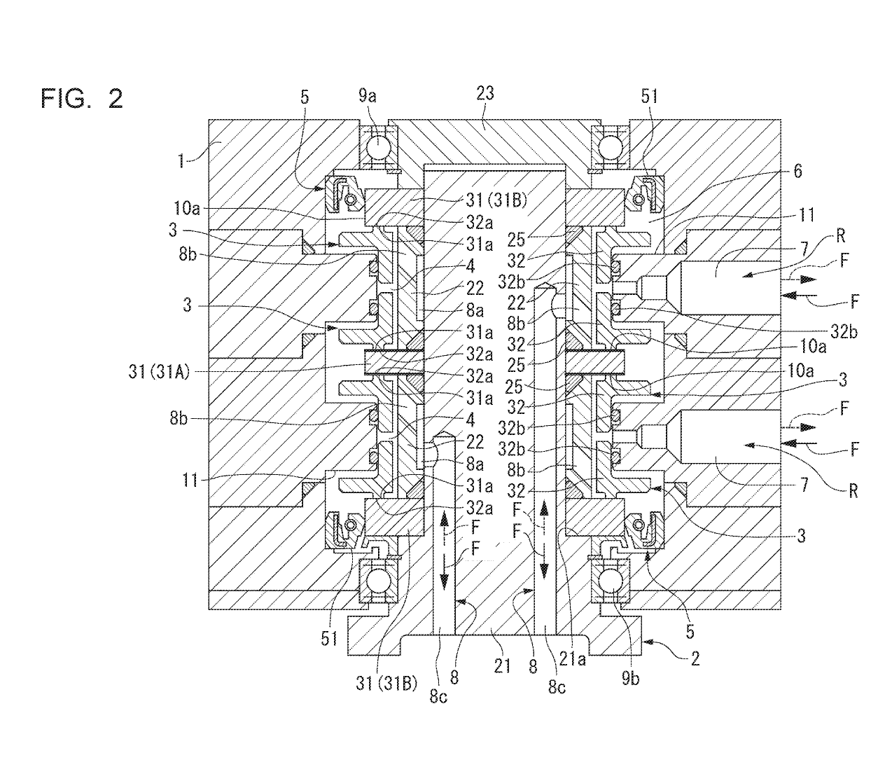

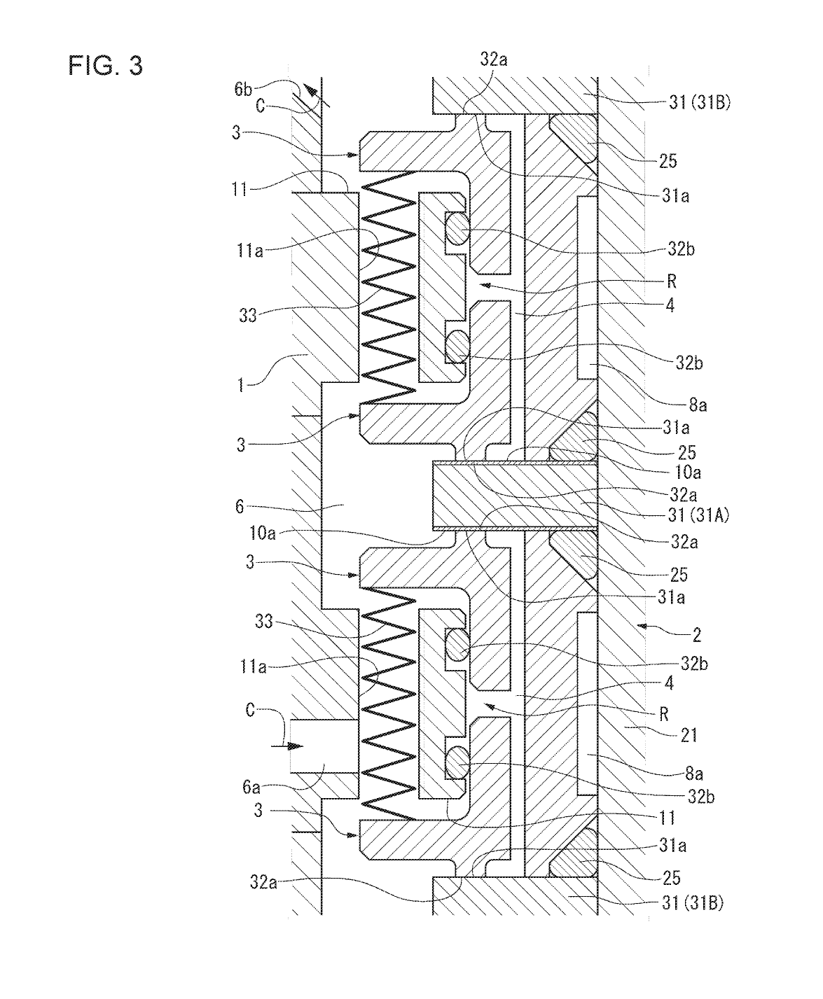

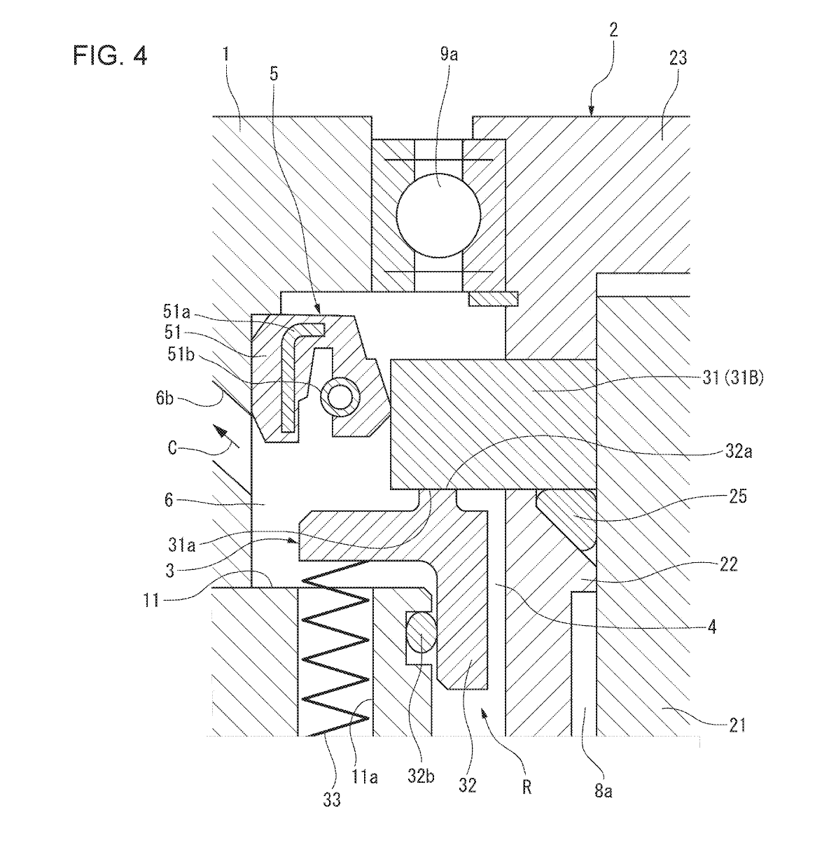

FIG. 1 is a cross-sectional view illustrating one example of the multi-channel rotary joint of the present invention, FIG. 2 is a cross-sectional view of this multi-channel rotary joint, in which the cross-section is taken at a location different from FIG. 1, FIG. 3 is an enlarged detailed cross-sectional view illustrating an essential portion of FIG. 1, and FIG. 4 is an enlarged detailed cross-sectional view illustrating an essential portion of FIG. 1 different from FIG. 3. It should be noted that the expressions “top” and “bottom” in the description below are assumed to refer to the “top” and “bottom” in FIGS. 1-4.

The multi-channel rotary joint illustrated in FIG. 1 and FIG. 2 (hereinafter referred to as the “first rotary joint”) is a vertical type joint provided with a tubular housing body 1 and a rotary shaft body 2 concentrically coupled thereto in a manner to make a relative rotation. Between the opposed peripheral surfaces of the two bodies 1 and 2, four or more mechanical seals 3 . . . are provided so as to be arranged in the direction of the rotational axis of the two bodies 1 and 2 (hereinafter referred to simply as “axial direction”), in other words, in a columnar configuration in the vertical direction. As a result, multiple passage connection spaces 4 . . . sealed by the adjacent mechanical seals 3, 3 next to each other are formed, and a cooling fluid space 6, which is a space defined by the passage connection space 4 and mechanical seals 3 and sealed by a pair of oil seals 5, 5 are also formed, and in addition, a series of multiple channels R . . . (see FIG. 2) that place the fluid passages 7, 8 in communication through the passage connection spaces 4 are formed between the two bodies 1, 2. The joint thus structured allows two or more types of fluid F to flow independently of each other between relatively rotating members in CMP apparatuses and other rotary devices.

As shown in FIGS. 1 and 2, the housing body 1 has a circular inner periphery, whose centerline extends in the vertical direction, and it takes a tubular structure that is split into multiple annular portions in the vertical direction. The housing body 1 is attached to a retaining member of a rotary device (e.g., the main body of a CMP apparatus).

As shown in FIGS. 1 and 2, the rotary shaft body 2 is made up of a cylindrical shaft main body 21, whose axial line extends in the vertical direction, multiple sleeves 22 . . . , which are matingly secured thereto in a columnar configuration at predetermined intervals in the vertical direction, and a close-bottomed cylinder-shaped bearing seat 23, which is matingly secured to the upper end portion of the shaft main body 21. The rotary shat body 2 is supported, in a manner to make a relative rotation concentrically with the inner periphery of the housing body 1, by a pair of top and bottom bearings 9a and 9b. The bearings 9a and 9b are provided, respectively, between the bearing seat 23 and the upper end portion of the housing body 1 and between a large-diameter bearing-receiving portion 21a formed in the lower end portion of the shaft main body 21a and the lower end portion of the housing body 1. The rotary shaft body 2 is attached to a rotational member of a rotary device (e.g., the top ring or turntable of a CMP apparatus) at the lower end portion of the shaft main body 21.

As shown in FIG. 1, each mechanical seal 3 is an end face contact-type mechanical seal, and it is comprised of a rotary seal ring 31, which is secured to the rotary shaft body 2, a stationary seal ring 32, which is supported on the housing body 1 so as to be movable in the axial direction with respect thereto, and a spring 33, which press-contacts the stationary seal ring 32 to the rotary seal ring 31. The mechanical seal 3 is adapted to use the relative rotational sliding contact action of sealing end faces 31a and 32a (i.e., the opposed end faces of the two seal rings 31 and 32) to seal the passage connection space 4, which is the inner peripheral region of the area of relative rotational sliding contact, and the cooling fluid space 6, which is its outer peripheral region. In this shown example, as seen from FIGS. 1 and 2, four mechanical seals 3 . . . are disposed in such a configuration that all the seal rings 31 . . . , 32 . . . are arranged in a column in the direction of the rotational axis, and rotary seal rings 31, 31 are located at both ends of this seal ring group 31 . . . , 32 . . . . In other words, two mechanical seal units, each comprising a pair of mechanical seals 3, 3 of a double-seal arrangement, wherein stationary seal rings 32, 32 are located between the two rotary seal rings 31, 31, are disposed in a column in the axial direction.

Each rotary seal ring 31 is an annular body with a rectangular cross-section concentric with the rotational axis of the two bodies 1, 2 (hereinafter referred to simply as an “axial line”); and, as seen from FIG. 3, the end faces that are in contact with the stationary seal rings 32 are constituted as sealing end faces 31a, which are smooth annular planar faces transverse to the axial line. In this example, as shown in FIG. 3, a single rotary seal ring 31, both end faces of which making sealing end faces 31a, 31a, performs double duty, so that it is used as the rotary seal ring 31 of one mechanical seal 3 and also as the rotary seal ring 31 of the mechanical seal 3 that is adjacent thereto. In other words, of the rotary seal rings 31 . . . which are arranged in a column in the vertical direction, the rotary seal ring 31, which is not (or except for) the rotary seal rings 31, 31 located at both ends (upper and lower ends), is formed with the sealing end faces 31a, 31a. It should be noted that, in the description below, when it is necessary to distinguish the rotary seal ring 31 performing double duty as the rotating double rings 31 for adjacent mechanical seals 3 (rotary seal ring 31 other than the rotary seal rings 31 located at the ends of the group of rotary seal rings 31 . . . ) from the rotary seal rings 31 that do not perform double duty (rotary seal rings 31 located at the ends of the group of rotary seal rings 31 . . . ) among the rotary seal rings 31 of the mechanical seals 3, the former rotary seal ring is referred to as “double-duty rotary seal ring 31A” and the latter rotary seal rings are referred to as “terminal rotary seal rings 31B”.

As shown in FIGS. 1 and 2, the rotary seal rings 31 are matingly secured to the main body 21 of the rotary shaft body 2 in such a configuration that the mutual spacing between the adjacent rotary seal rings 31 is restricted by the sleeves 22. More specifically, as shown in FIG. 1, by fastening the bearing seat 23 to the shaft main body 21 using a bolt 24, the rotary seal rings 31 are clamped and held between the bearing-receiving portion 21a and the bearing seat 23 with the sleeves 22 interposed therebetween, and they are secured to the rotary shaft body 2 in a columnar configuration at regular intervals in the axial direction. It should be noted that, as shown in FIG. 3, O-rings 25, which seal the area of fitting engagement between the shaft main body 21 and the rotary seal rings 31, are provided between the shaft main body 21 and the inner periphery of the sleeves 22.

As shown in FIG. 3, the stationary seal rings 32 are annular bodies with a substantially L-shaped cross-section concentric with the axial line, and the end faces of their distal protrusions are constituted as sealing end faces 32a, which are smooth annular planar faces transverse to the axial line. The sealing end faces 32a of the stationary seal rings 32, whose radial face width (sealing face width) is smaller than the radial face width of the sealing end faces 31a of the rotary seal ring 31, are brought into contact with the sealing end faces 31a in such a configuration that the inner and outer peripheral portions of the sealing end faces 31a protrude in the radial direction from the sealing end faces 32a of the stationary seal rings 32. In other words, the inside diameter of the sealing end faces 32a of the stationary seal rings 32 is set to be larger than the inside diameter of the sealing end faces 31a of the rotary seal ring 31, and their outside diameter is set to be smaller than the outside diameter of the sealing end faces 31a of the rotary seal ring 31. As shown in FIG. 1 and FIG. 3, each stationary seal ring 32 is fitted under and held by an annular wall 11 that protrudes from the inner periphery of the housing body 1 with an O-ring 32b interposed therebetween, so as to be movable in the axial direction. Furthermore, as shown in FIG. 1, by way of engaging drive pins 32c, which protrude from the annular wall 11 in the axial direction, with engagement recesses formed in the outer peripheral portion of the stationary seal ring 32, the stationary seal ring 32 is held on the housing body 1 so as to not make relative rotation in such a configuration that a relative travel in the axial direction within a predetermined range is permitted. In this example, as seen from FIG. 1, a driver that passes through the annular walls 11, 11 in the axial direction and is supported thereby is used simultaneously for all the drive pins 32c.

As shown in FIG. 1, in each mechanical seal unit, a spring 33 is loaded in a cross-over hole 11a, which passes through the annular wall 11 in the axial direction, and it serves as a common member biasing the two stationary seal rings 32, 32 located on both sides of the annular wall 11 towards the rotary seal rings 31.

As shown in FIG. 2, fluid passages 7, 8, which are placed in communication with the passage connection spaces 4, are formed in the two bodies 1, 2. In this example, two channels R, R are formed between the two bodies 1, 2 to permit fluids F to flow independently of each other in the direction of the arrows (in the direction of the arrows indicated by solid lines or dashed lines) between the two bodies 1, 2 through the two fluid passages 7, 8 and the passage connection spaces 4. The fluid passages 7 of the housing body 1 are formed to pass through the housing body 11 in the radial direction, with one end thereof opening into the passage connection space 4 on the inner peripheral surface of the annular wall 11, and the other end thereof connected to a fluid passage formed in the retaining member of the rotary device. The fluid passages 8 formed in the rotary shaft body 2 are made up of an annular header space 8a, which is formed between the opposed peripheral surfaces of the shaft main body 21 and the sleeves 22, multiple cross-over holes 8b . . . , which pass through the sleeves 22 in the radial direction and place the header space 8a in communication with the passage connection space 4, and a fluid passage main body 8c, which passes through the shaft main body 21 from its lower end portion in the axial direction and opens into the header space 8a, with the lower end portion of the fluid passage main body 8c being connected to a fluid passage formed in the rotational member of the rotary device. The material of the seal rings 31, 31A, and 32 is selected in accordance with the conditions of use of the rotary joint, such as the properties of fluids F flowing through channels R, and it is normally comprised of cemented carbide (tungsten carbide) or ceramics, such as silicon carbide and the like.

As shown in FIGS. 1 and 2, the two oil seals 5, 5 are disposed at both ends of the mechanical seal group 3 . . . between the two bearings 9a, 9b. The oil seals are made up of rotary seal rings 31, 31 (terminal rotary seal rings 31B, 31B) located at the two ends (upper and lower end) of the seal ring groups 31 . . . , 32 . . . aligned in the axial direction and the annular sealing members 51, 51 made of an elastic material, such as rubber and the like, which are secured to the inner periphery of the housing body 1 and apply pressure to the outer peripheral surface of the terminal rotary seal rings 31B, 31B. The annular sealing members 51 are well-known devices, and, as shown in FIG. 4, they are comprised of a main body, which has a reinforcing bracket 51a made of metal (SUS304, etc.) embedded therein and is fittingly secured to the inner periphery of the housing body 1, and a lip seal portion, which is tightly fastened and pressed against the outer peripheral surface of the terminal rotary seal ring 31B by a garter spring 51b to effect sealing capabilities (hereinafter referred to as “oil sealing capabilities”).

The cooling fluid space 6 sealed by the two oil seals 5, 5 is formed between the opposed peripheral surfaces of the two bodies 1, 2. This fluid space 6 is a space constituted by the outer peripheral region of the area of relative rotational sliding contact of the two sealing end faces 31a, 32a in each mechanical seal 3 and by the cross-over holes 11a formed in the annular walls 11 that partition the outer peripheral region. A suitable cooling fluid C is cyclically supplied to this cooling fluid space 6. In this example, fluids such as room temperature water and the like are used as cooling fluid C. In other words, as shown in FIG. 1, in the casing body 1, a cooling fluid supply passage 6a and a cooling fluid discharge passage 6b, which open into the upper and lower end portions of the cooling fluid space 6 and which are used to supply and discharge cooling fluid C, are formed in the housing body 1 to allow for cooling fluid C to be cyclically supplied to the cooling fluid space 6. As shown in FIG. 1, the housing body 1 has drains 13a, 13b formed therein, which open into the space between the opposed peripheral surfaces of the two bodies 1, 2 between the oil seals 5 and bearings 9a, 9b.

As shown in FIGS. 1-3, coating layers 10a, 10a, which are made up of a material with a higher heat transfer coefficient and hardness and with a lower coefficient of friction compared to the material of the double-duty rotary seal ring 31A, are formed on the two sealing end faces 31a, 31a of the double-duty rotary seal ring 31A. It should be noted that when in the description below it is necessary to distinguish between a seal ring and a coating layer applied thereto, the former is referred to as seal ring base material.

Even though the material of the double-duty rotary seal ring 31A (material constituting the seal ring base material) is a seal ring material such as ceramics, cemented carbide, and the like, the material of the coating layers 10a, 10a is diamond, whose heat transfer coefficient and hardness are higher and whose coefficient of friction is lower than those of the seal ring. The diamond coating layers 10a, 10a are formed using coating methods such as hot filament chemical vapor deposition, microwave plasma chemical vapor deposition, radio-frequency plasma, DC discharge plasma, arc discharge plasma jetting, combustion flame, and the like.

In the first rotary joint formed as described above, on the two sealing end faces 31a, 31a of the double-duty rotary seal ring 31A, there are formed coating layers 10a, 10a, which are made from a material whose hardness is higher and whose coefficient of friction is lower than those of the material of which the rings are made (material constituting the seal ring base material). Accordingly, the amount of wear and heat generated in the area of relative rotational sliding contact of the sealing end faces 31a with the counterpart sealing end faces (sealing end faces of the stationary seal rings 32) 32a is reduced compared to the case in which the sealing end faces of the rotary seal ring and the sealing end faces of the stationary seal rings are directly in relative rotational sliding contact, in other words, in which the base materials of the seal rings are in direct relative rotational sliding contact, as is the case in the conventional rotary joints described in the beginning of the present specification. In particular, if the coating layers 10a are made from diamond as described above, the wear and heat generated by the relative rotational sliding contact between the sealing end faces 31a covered by the coating layers 10a in the double-duty rotary seal ring 31A and the sealing end faces 32a of the counterpart seal rings (stationary seal rings) 32 is extremely small because diamond is the hardest of all the naturally occurring solid materials and its coefficient of friction is extremely low compared to seal ring materials such as silicon carbide and the like (in general, the coefficient of friction of diamond is 0.03 (μ), i.e., more than 10% lower than the coefficient of friction of PTFE (polytetrafluoroethylene), which is considerably lower compared to the various seal ring materials).

In addition, as seen from the above, the coating layers 10a are made up of a material with a higher heat transfer coefficient compared to the material of the double-duty rotary seal ring 31A, and the radial face width of the sealing end faces 32a of the stationary seal rings 32 is smaller than the radial face width of the sealing end faces 31a of the double-duty rotary seal ring 31A in contact therewith. Accordingly, heat generated on the sealing end faces 32a of the stationary seal rings 32 is transferred to and absorbed by the high thermal conductivity coating layers 10a formed on the counterpart sealing end faces 31a; and as a result, the temperature of the sealing end faces 32a decreases. On the other hand, in the coating layers 10a formed on the double-duty rotary seal ring 31A, the protruding portions, which protrude on the inner and outer peripheral sides away from the areas of contact with the sealing end faces 32a of the stationary seal rings 32, are in contact with fluids F passing through channels R as well as with cooling fluid C cyclically supplied to the cooling fluid space 6. Accordingly, heat generated by the relative rotational sliding contact with the sealing end faces 32a is dissipated from the protruding portions into fluids F and cooling fluid C, the sealing end faces 32a are preferably cooled by fluids F and cooling fluid C.

The heat dissipation and cooling, which result from the absorption of heat from the counterpart sealing end faces 32a as well as from contact with fluids F and cooling fluid C on two end faces 31a, 31a of the double-duty rotary seal ring 31A, are accomplished in an extremely efficient manner, because, as described above, the coating layers 10a, 10a are made from diamond, and diamond has the highest thermal conductivity of all the solid materials and its thermal conductivity is extremely high compared to seal ring materials such as ceramics, cemented carbide, and the like (for example, while the thermal conductivity of silicon carbide is 70-120 W/m·K, the thermal conductivity of diamond is 1000-2000 W/m·K).

In addition, it can occur that the contact pressure of the two sealing end faces 31a, 32a in one of the mechanical seals 3 differs from the contact pressure of the two sealing end faces 31a, 32a in the other mechanical seal 3; and this would be caused by the differences in the pressure of the fluids F, F flowing through the respective passage connection spaces 4, 4 sealed by the two mechanical seals 3, 3 (mechanical seal units), which utilize the double-duty rotary seal ring 31A as their rotary seal ring, or by variations in the pressure of each of such fluids F. If this occurs, the amount of heat generated in the areas of relative rotational sliding contact with the sealing end faces 31a, 32a in the two mechanical seals 3, 3 could be different, resulting in a significant temperature difference between the two sealing end faces 31a, 31a of the double-duty rotary seal ring 31A and a development of thermal strain on the sealing end faces 31a, 31a. However, such risks are eliminated by the above-described coating layers 10a, 10a covering both end faces 31a, 31a of the double-duty rotary seal ring 31A. In other words, the reduction in the amount of heat generated by the contact of the coating layers 10a with the counterpart sealing end faces 32a and the promotion of cooling by fluids F and C, as described above, reduce the temperature to which the two sealing end faces 31a, 31a are heated, make the temperature difference between the sealing end faces 31a, 31a extremely small, and ensure maximum prevention of thermal strain development due to temperature differences between the two sealing end faces 31a, 31a.

Consequently, the relative rotational sliding contact between the two end faces 31a, 31a of the double-duty rotary seal ring 31A and the counterpart seal rings 32, 32 is executed correctly, providing excellent mechanical sealing capabilities for an extended period of time. As a result, it becomes possible to ensure adequate flow of fluids F along the channels R without creating problems characteristic of the conventional rotary joints and without producing fluid leaks from the passage connection spaces 4.

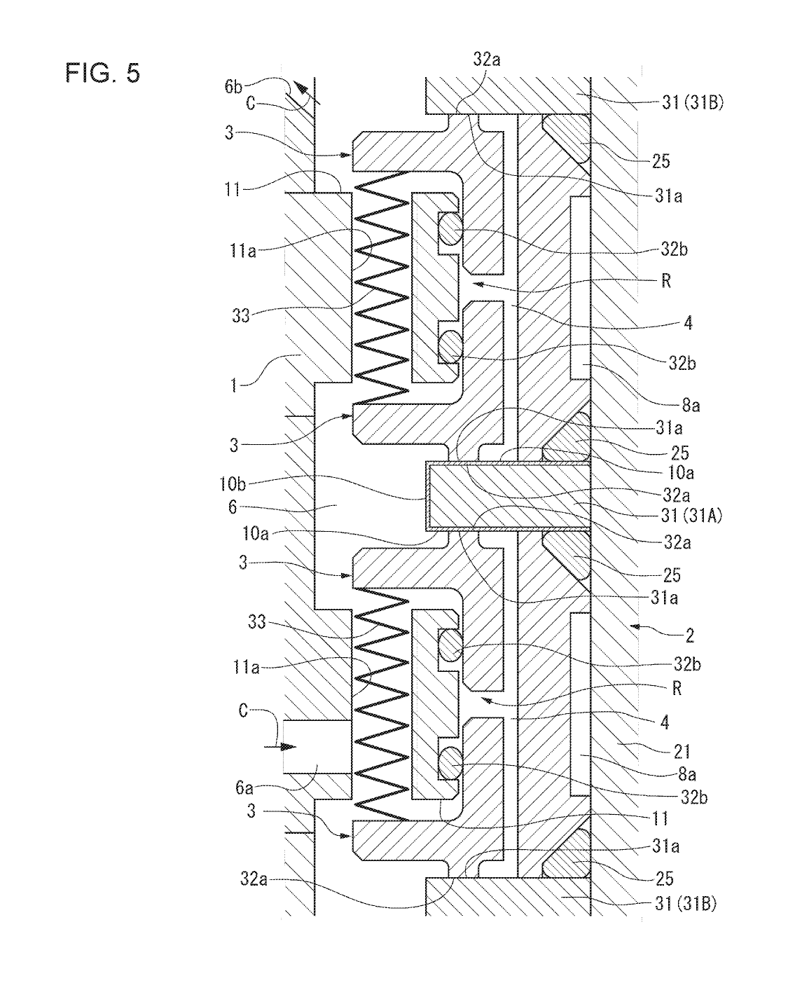

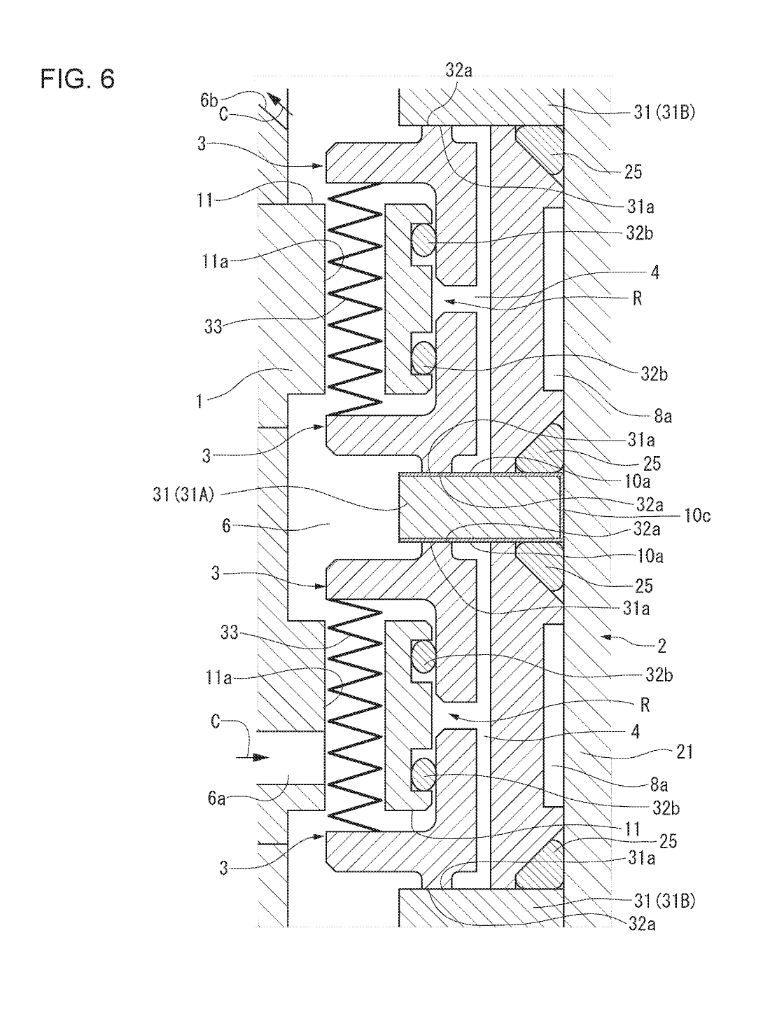

Incidentally, as shown in FIG. 5 or FIG. 6, the development of thermal strain that adversely affects the sealing capabilities of the mechanical seals in the two sealing end faces 31a, 31a of the double-duty rotary seal ring 31A can be prevented in a more efficient manner by continuously forming coating layers, which are made from a material with a higher heat transfer coefficient and hardness compared to the material of the double-duty rotary seal ring 31A, on either of the inner and outer peripheral surfaces in addition to both end faces (sealing end faces) 31a, 31a of the double-duty rotary seal ring 31A.

More specifically, FIG. 5 is a cross-sectional view of an essential portion corresponding to FIG. 3 that illustrates a variation of the multi-channel rotary joint, and in this multi-channel rotary joint illustrated in FIG. 5 (hereinafter referred to as the “second rotary joint”), coating layers 10a, 10a, 10b are formed continuously on the two sealing end faces 31a, 31a and on the outer peripheral surface of the double-duty rotary seal ring 31A. In other words, the coating layer is comprised of the sealing end face coating layers 10a and 10a, which cover the entire surface of both end faces 31a, 31a of the double-duty rotary seal ring 31A, and the outer peripheral surface coating layer 10b, which is continuous to the coating layers 10a and 10a and covers the entire surface of the outer peripheral surface of said rotary seal ring 31A. In addition, FIG. 6 is a cross-sectional view of an essential portion corresponding to FIG. 3 that illustrates another variation of the multi-channel rotary joint of the present invention. In the multi-channel rotary joint of FIG. 6 (hereinafter referred to as the “third rotary joint”), on both end faces 31a, 31a and on the inner peripheral surface of the double-duty rotary seal ring 31A, there are formed layers which continuously cover the entire surface thereof, comprising, namely, sealing end face coating layers 10a and 10a and an inner peripheral surface coating layer 10c. It should be noted that, with the exception of the points described above, the second and third rotary joints have the same construction as the first rotary joint of FIGS. 1-4. For this reason, in FIGS. 5 and 6, elements similar to those of the first rotary joint are assigned the same reference numerals as the reference numerals used in FIGS. 1-4, and detailed descriptions thereof are omitted.

The coating layers 10a, 10b, 10c are made from a material with a higher heat transfer coefficient and hardness and a lower coefficient of friction compared to the material of the seal ring base material of the double-duty rotary seal ring 31A. Thus, in the examples illustrated in FIG. 5 and FIG. 6, the materials of construction of the double-duty rotary seal ring 31A (seal ring base materials) include ceramics, cemented carbide, and various other seal ring materials, while the material used for the coating layers 10a, 10b, 10c is diamond, which has a relatively higher heat transfer coefficient and hardness and a lower coefficient of friction. As described above, the diamond coating layers 10a, 10b, and 10c are formed using hot filament chemical vapor deposition and the like as described above.

In the second and third rotary joints configured as described above, the sealing end face coating layers 10a, 10a are formed on the two sealing end faces 31a, 31a of the double-duty rotary seal ring 31A using a material having a higher hardness and a lower coefficient of friction than those of the material the ring is made of (material constituting the seal ring base material). Accordingly, the amount of wear and heat generated in the area of relative rotational sliding contact between the sealing end faces 31a and the counterpart sealing end faces (sealing end faces of the stationary seal rings 32) 32a is reduced compared to cases in which, in the same manner as in the conventional rotary joint, the sealing end faces of the rotary seal ring are in relative rotation directly with respect to the sealing end faces of the stationary seal rings, in other words, cases in which the base materials of the respective seal rings are in direct relative rotational sliding contact with each other. In particular, as described above, diamond is the hardest naturally occurring solid material and has a coefficient of friction that is extremely low compared to seal ring materials such as silicon carbide and the like. For this reason, because of the coating layers 10a made from diamond as in the above-described manner, the wear and heat generated by the relative rotational sliding contact between the sealing end faces 31a covered by the sealing end face coating layers 10a in the double-duty rotary seal ring 31A and the sealing end faces 32a of the counterpart seal rings (stationary seal rings) 32 is extremely small.

Moreover, the two sealing end face coating layers 10a, 10a formed on the double-duty rotary seal ring 31A are continuous to the inner peripheral surface coating layer 10c or outer peripheral surface coating layer 10b made from a material (diamond) having a higher thermal conductivity compared to the material constituting the double-duty rotary seal ring 31A. Accordingly, heat generated in the two sealing end face coating layers 10a, 10a is mutually transferred through the outer peripheral surface coating layer 10b or inner peripheral surface coating layer 10c and homogenized, even though, as described above, the amount of heat generated in the area of relative rotational sliding contact between one of the sealing end faces 31a of the double-duty rotary seal ring 31A and a sealing end face 32a of a stationary seal ring 32 is different from the heat generated in the area of relative rotational sliding contact between the other sealing end face 31a of the double-duty rotary seal ring 31A and a sealing end face 32a of another stationary seal ring 32. Therefore, the two sealing end face coating layers 10a, 10a are brought to a uniform temperature, in other words, both end faces 31a, 31a made of the seal ring base material in the double-duty rotary seal ring 31A are brought to the same temperature; and therefore, even though the amount of heat generated as a result of the relative rotational sliding contact with the counterpart sealing end faces 32a, 32a may be different, thermal strain development in the double-duty rotary seal ring 31A is effectively prevented and no significant thermal strain that adversely affects the mechanical sealing capabilities is developed in the two sealing end faces 31a, 31a of the double-duty rotary seal ring 31A.

Furthermore, since the radial face width of the sealing end faces 32a of the stationary seal rings 32 is smaller than the radial face width of the sealing end faces 31a of the double-duty rotary seal ring 31A, heat generated in the sealing end faces 32a of the stationary seal rings 32 is transferred to, and absorbed by, the high thermal conductivity sealing end face coating layers 10a formed on the counterpart sealing end faces 31a, thus reducing the temperature of the sealing end faces 32a. On the other hand, in the sealing end face coating layers 10a of the double-duty rotary seal ring 31A, the protruding portions, which protrude on the inner and outer peripheral sides away from the areas of contact with the sealing end faces 32a of the stationary seal rings 32, are in contact with fluids F passing through channels R as well as cooling fluid C cyclically supplied to the cooling fluid space 6; accordingly, heat generated by the relative rotational sliding contact with the sealing end faces 32a is dissipated from the protruding portions into fluids F and cooling fluid C, and those portions are cooled by fluids F and cooling fluid C. Such heat dissipation and cooling is accomplished in a more efficient manner due to the fact that the area of contact with cooling fluid C is increased by the inner peripheral surface coating layer 10c or outer peripheral surface coating layer 10b that are continuous to the two sealing end face coating layers 10a, 10a.

Such temperature homogenization of the two end faces 31a, 31a of the double-duty rotary seal ring 31A as well as such heat dissipation and cooling due to contact with the fluids F and cooling fluid C are performed in a more efficient manner because the coating layers 10a, 10b, 10c are made from diamond which, as described above, has the highest thermal conductivity of all the solid materials and has a thermal conductivity that is extremely high compared to seal ring materials such as ceramics, cemented carbide, and the like.

Accordingly, in the second and third rotary joints, despite the generation of heat by both end faces 31a, 31a as a result of the relative rotational sliding contact with the counterpart seal rings 32, 32, the double-duty rotary seal ring 31A can prevent wear, heat generation, and thermal strain on both end faces 31a, 31a as much as possible and provides excellent mechanical sealing capabilities for an extended period of time even when the amount of heat generated in the two end faces 31a, 31a is different.

Incidentally, in the conventional rotary joint described at the beginning of this specification, the oil seals are formed by the rotary seal rings (terminal rotary seal rings) of the mechanical seals, which leads to problems including adverse effects on the sealing capabilities (mechanical sealing capabilities) of the mechanical seals comprising said rotary seal rings as components. In other words, since the area of relative rotational sliding contact between the annular sealing members in the oil seals and the outer peripheral surface of the rotary seal rings generates heat, there is a risk that significant thermal strain that adversely affects the mechanical sealing capabilities could be generated in the sealing end faces of the rotary seal ring when the heat is combined with the heat generated by the end faces (sealing end faces) of the rotary seal ring as a result of the relative rotational sliding contact with the stationary seal rings. In other words, the sealing end faces and the outer peripheral surface of the rotary seal ring generate heat as a result of the relative rotational sliding contact with the stationary seal rings and the annular sealing member. Since the amount of heat they generate is different, there is a temperature difference between the sealing end faces and the outer peripheral surfaces of the rotary seal rings. There is also a significant temperature difference between, on the one hand, these sealing end faces and the outer peripheral surface, and, on the other hand, the end faces on the side opposite the sealing end faces, because the end faces do not generate heat, which makes the surface temperature of said rotary seal ring uneven, and, as a result, creates a risk of developing significant thermal strain on the sealing end faces. In addition, each oil seal is configured to display sealing capabilities (oil sealing capabilities) by bringing an annular sealing member made of rubber into contact with the outer peripheral surface of a rotary seal ring made of silicon carbide. However, because of the high coefficient of friction with silicon carbide, wear takes place in the area of relative rotational sliding contact of the annular sealing member and the rotary seal ring even though the area is lubricated by the cooling water, and it is difficult to ensure oil sealing capabilities for an extended period of time. In particular, in a structure that the rotational axis of the housing body and rotary shaft body extends in the vertical direction, as is the case in the conventional rotary joints described above, an air reservoir free of coolant may be created in the top portion of the cooling fluid space and, in some cases, adequate lubrication by coolant may be impossible in the area of contact between the annular sealing member and the rotary seal ring in the top oil seal. Consequently, due to the considerable levels of wear and heat generated in the area of contact, adequate sealing of the cooling fluid space may not be possible even if the oil seal below displays normal oil sealing capabilities, and, moreover, there is a risk that thermal strain could be developed on the surface of contact between the rotary seal ring and the stationary seal ring constituting the top oil seal, which would also reduce the mechanical sealing capabilities of said two seal rings. In this manner, in a rotary joint in which the rotational axis of the housing body and rotary shaft body extends in the vertical direction, the reliability of the top oil seal is low and its oil sealing capabilities are extremely unstable. In addition, the mechanical sealing capabilities of the topmost mechanical seal are not stable either.

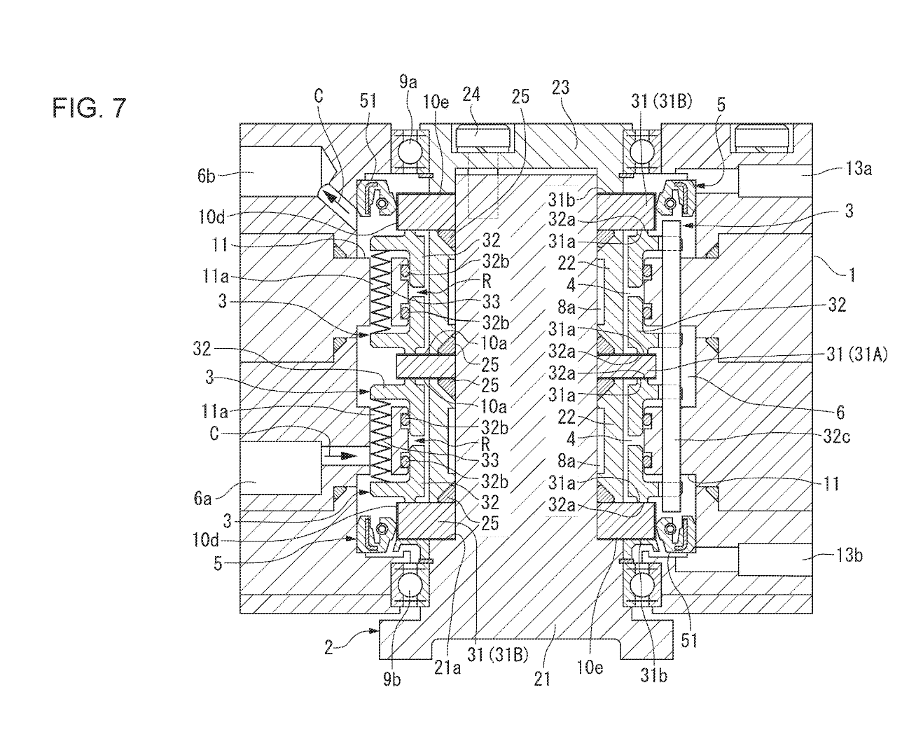

As shown in FIGS. 7-9, such problems as described above can be eliminated by continuously forming coating layers 10d, 10e, which are made from a material with a higher heat transfer coefficient and hardness and a lower coefficient of friction compared to the material (material constituting the seal ring base material) used for the terminal rotary seal rings 31B, on the outer peripheral surface of the rotary seal rings 31 (terminal rotary seal rings 31B) that form each oil seal 5 as well as on one of their two end faces, that is, on the end face (non-sealing end face) 31b on the side opposite the sealing end face 31a.

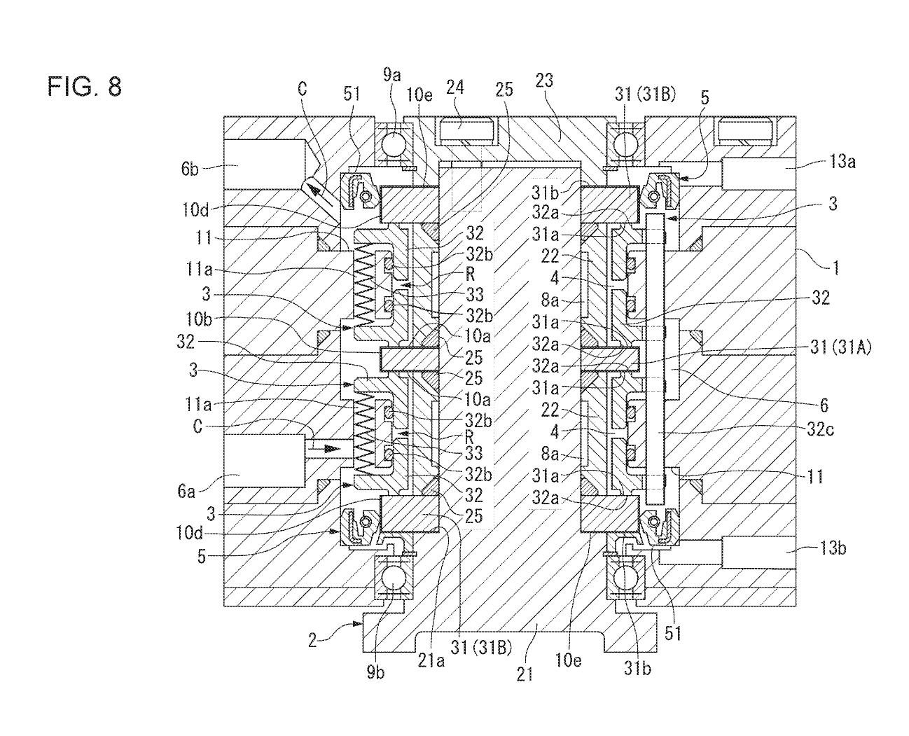

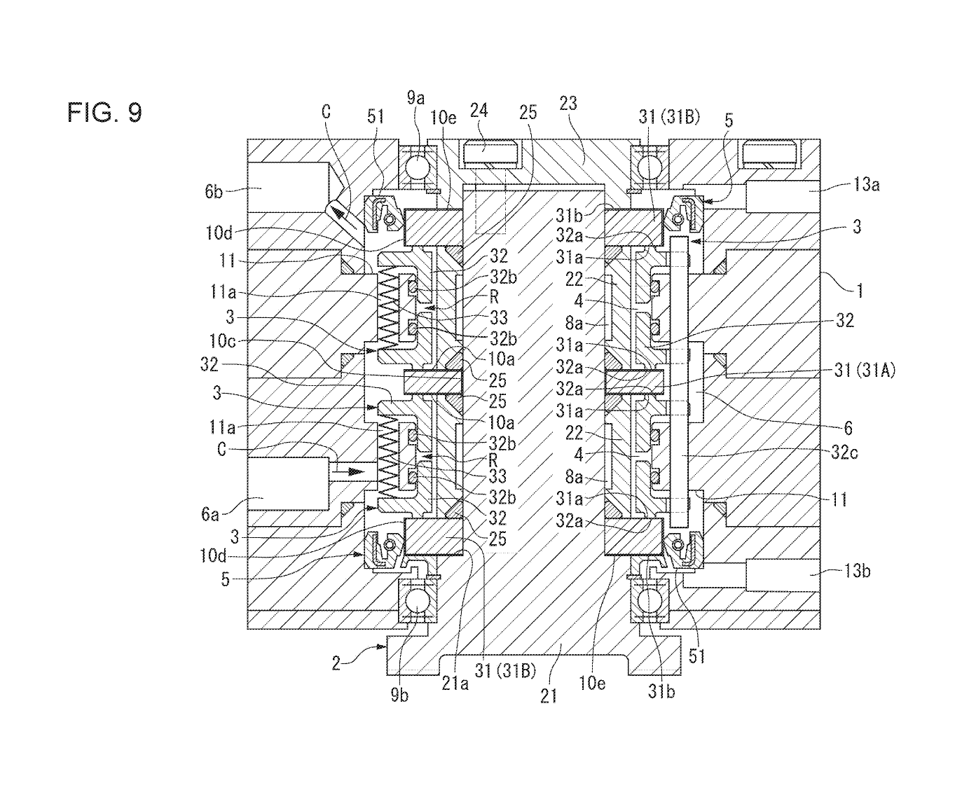

More specific description will be made with reference to FIGS. 7-9 which are cross-sectional views corresponding to FIG. 1 and illustrate still other variations of the multi-channel rotary joint of the present invention. In the multi-channel rotary joint of the present invention illustrated in FIG. 7 (hereinafter referred to as the “fourth rotary joint”), in the multi-channel rotary joint of the present invention illustrated in FIG. 8 (hereinafter referred to as the “fifth rotary joint”), and in the multi-channel rotary joint of the present invention illustrated in FIG. 9 (hereinafter referred to as the “sixth rotary joint”), respectively, an outer peripheral surface coating layer 10d is formed on the outer peripheral surface of each terminal rotary seal ring 31B so as to cover its entire surface, and a non-sealing end face coating layer 10e is further formed continuously thereto on the non-sealing end face 31b of the terminal rotary seal ring 31B so as to cover its entire surface. Although the material (material constituting the seal ring base material) of the terminal rotary seal rings 31B in the examples illustrated in FIGS. 7-9 includes ceramics, cemented carbide, and various other seal ring materials, the material used for the coating layers 10d, 10e is diamond, which has a higher heat transfer coefficient and hardness and a lower coefficient of friction. As described above, the diamond coating layers 10d, 10e are formed using hot filament chemical vapor deposition and the like. It should be noted that, with the exception of the points described above, the fourth rotary joint has the same construction as the first rotary joint, the fifth rotary joint has the same construction as the second rotary joint, and the sixth rotary joint has the same construction as the third rotary joint, respectively; for this reason, in FIGS. 7-9, elements similar to those of the first, second and third rotary joints are assigned with the same reference numerals as the reference numerals used in FIGS. 1-6, and detailed descriptions thereof are omitted.

In each oil seal 5 in the thus configured fourth through sixth rotary joints, the outer peripheral surface coating layer 10d, which is made of a material with a higher hardness and a lower coefficient of friction than the material the rings are made of (material constituting the seal ring base material), is formed on the outer peripheral surface of the terminal rotary seal rings 31B, with which the annular sealing members 51 are in relative rotational sliding contact. For this reason, the amount of wear and heat generated in the area of relative rotational sliding contact of 31B and 51 is reduced compared to the case in which the annular sealing members are in direct relative rotational sliding contact with the outer peripheral surfaces (outer peripheral surface made of the seal ring base material) of the terminal rotary seal rings, as is the case in the conventional rotary joint. In particular, with diamond being the hardest of all the naturally occurring solid materials and having a coefficient of friction that is extremely low compared to silicon carbide and various other seal ring materials, as described above, the amount of wear and heat generated by the relative rotational sliding contact between the annular sealing members 51 and the outer peripheral surface coating layer 10d is extremely small for the outer peripheral surface coating layer 10d made from diamond in the above-described manner.

Incidentally, while a further reduction in the wear and heat generated in the area of relative sliding contact between the annular sealing members 51 and the outer peripheral surface coating layer 10d is expected because the area of relative sliding contact is lubricated and cooled by cooling fluid C supplied to the cooling fluid space 6, the contribution of the lubrication and cooling provided by cooling fluid C to such a reduction in wear and heat generation is extremely small compared to the contribution of the outer peripheral surface coating layer 10d (contribution due to the fact that forming the coating layer 10d reduces frictional forces and improves anti-wear properties). Therefore, even if cooling fluid C is not supplied to the cooling fluid space 6 (e.g., if cooling fluid C used in the cooling fluid space 6 is a gas, such as atmospheric air or nitrogen), in other words, even if the area of relative rotational sliding contact between the annular sealing member 51 and the outer peripheral surface coating layer 10d is in dry atmosphere, the wear and heat generated in such area of relative rotational sliding contact is reduced to a sufficient extent similar to the case in which cooling fluid C is supplied to the cooling fluid space 6. For this reason, if cooling fluid C is supplied to the cooling fluid space 6, the oil sealing capabilities of the top oil seal 5 are displayed to the same extent as the oil sealing capabilities of the bottom oil seal 5, which is in constant contact with cooling fluid C, and there is practically no difference in terms of durability and oil sealing capabilities between the two oil seals 5, 5 even when the area of relative rotational sliding contact in said top oil seal 5 is in dry atmosphere because of the air reservoir created in the above-described manner. In other words, there is no significant reduction in the durability and oil sealing capabilities of the top oil seal 5 in comparison with the bottom oil seal 5 because of the air reservoir that is created, and the two oil seals 5, 5 provide excellent oil sealing capabilities for an extended period of time.

In addition, the coating layers 10d, 10e are made from a material having a higher thermal conductivity than the material of the terminal rotary seal rings 31B, and the coating layer 10e, which is a non-sealing end face coating layer connected to the coating layer 10d that is an outer peripheral surface coating layer, is formed on the non-sealing end faces 31b of the terminal rotary seal rings 31B; accordingly, the heat generated by the relative rotational sliding contact of the annular sealing members 51 with the outer peripheral surface coating layer 10d formed on the outer peripheral surface of the terminal rotary seal rings 31B is transferred from the outer peripheral surface coating layer 10d to the non-sealing end face coating layer 10e faster than to the seal ring base material of the terminal rotary seal rings 31B, thus heating the non-sealing end face 31b of the seal ring base material. For this reason, the temperature difference between the sealing end faces 31a of the terminal rotary seal rings 31B, which generate heat as a result of the relative rotational sliding contact with the stationary seal rings 32, and the end faces (non-sealing end faces) 31b on the opposite side is reduced, and there is no significant temperature difference between the two end faces (the two end faces made of the seal ring base material) 31a, 31b of the terminal rotary seal rings 31B. As a result, there is no risk of significant thermal strain that adversely affects the mechanical sealing capabilities being developed on the sealing end faces 31a of the terminal rotary seal rings 31B. In particular, as described above, diamond has the highest thermal conductivity of all the solid materials, and since the coating layers 10d, 10e are made from diamond, as described above, the above-described effects are provided in a pronounced manner since its thermal conductivity is extremely high compared to ceramics, cemented carbide, and various other seal ring materials used as the material of construction of the terminal rotary seal rings 31B.

As described above, compared to the above-described conventional rotary joint, in the fourth through sixth rotary joints, in addition to the improved durability of the oil seals 5, 5, heat generation due to the relative rotational sliding contact of the annular sealing members 51 with the terminal rotary seal rings 31B does not induce and promote thermal strain development on the sealing end faces 31a of the terminal rotary seal rings 31B, and thus it is possible to eliminate adverse effects on mechanical sealing capabilities due to the structure that the sealing surfaces of the oil seals 5 are constituted by the outer peripheral surfaces of the terminal rotary seal rings 31A.

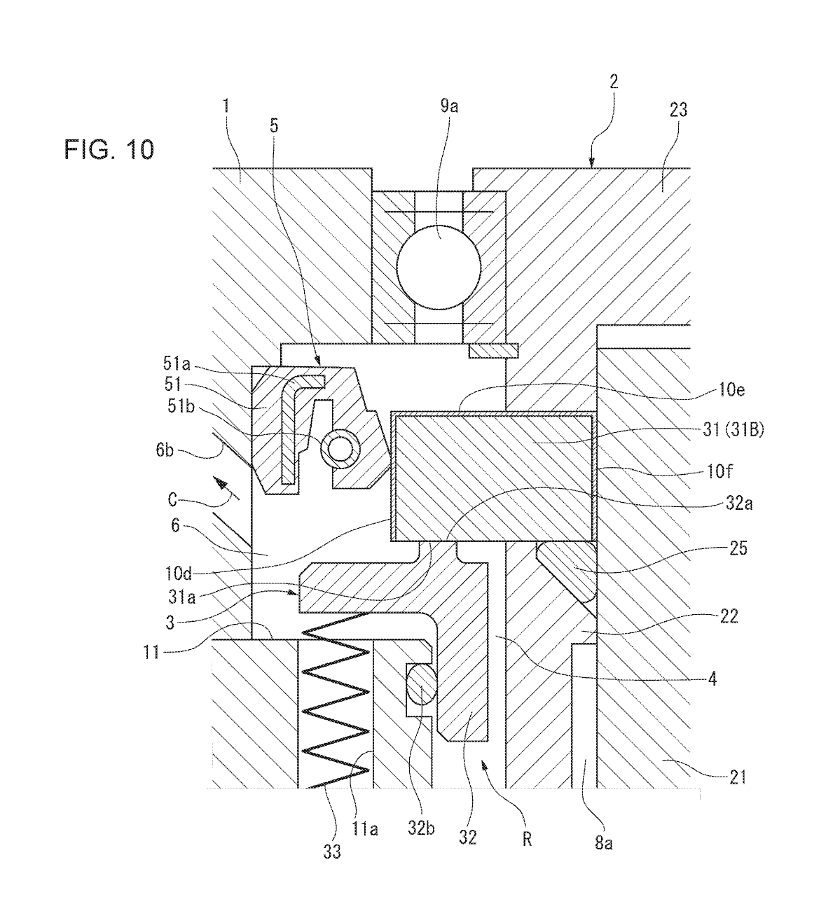

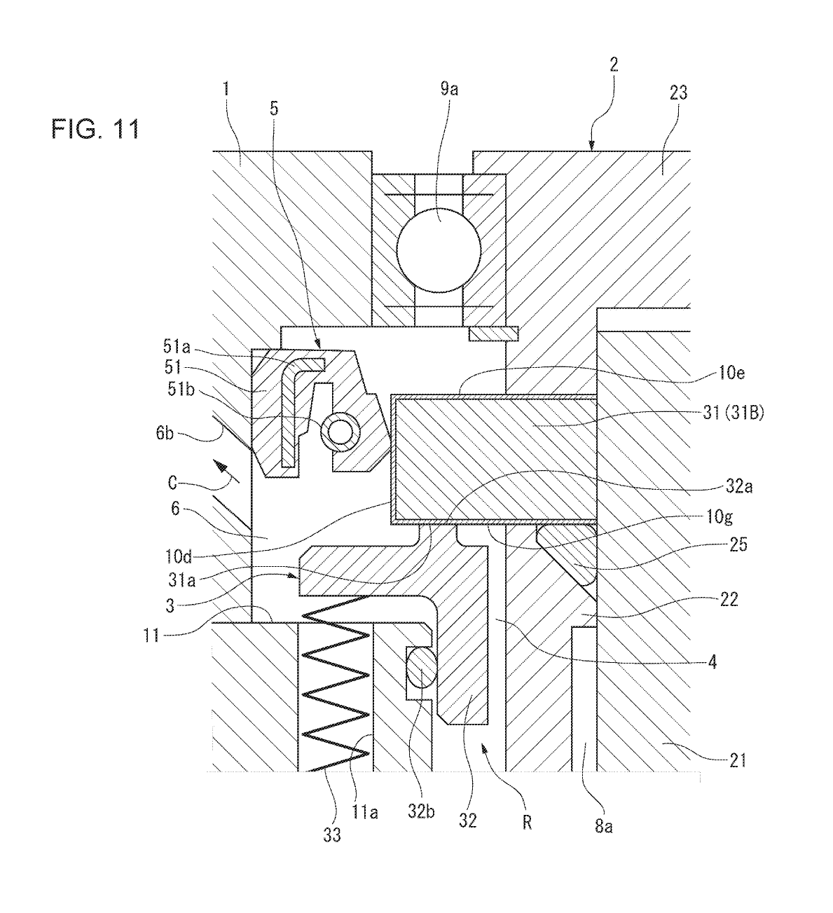

Furthermore, in the fourth through sixth rotary joints, as shown in FIG. 10 or FIG. 11, in addition to the outer peripheral surface coating layer 10d and non-sealing end face coating layer 10e, coating layers can also be formed on the sealing end faces 31a or on the inner peripheral surfaces of the terminal rotary seal rings 31B. FIG. 10 and FIG. 11 are cross-sectional views of an essential portion corresponding to FIG. 3 that illustrate still other variations of the multi-channel rotary joint of the present invention. In the multi-channel rotary joint of the present invention of FIG. 10 (hereinafter referred to as the “seventh rotary joint”), an inner peripheral surface coating layer 10f, which is continuous to the non-sealing end face coating layer 10e, is formed on the inner peripheral surfaces of the terminal rotary seal rings 31B. In the multi-channel rotary joint of the present invention of FIG. 11 (hereinafter referred to as the “eighth rotary joint”), a sealing end face coating layer 10g, which is continuous to the outer peripheral surface coating layer 10d, is formed on the sealing end faces 31a of the terminal rotary seal rings 31B. It should be noted that, with the exception of the points described above, the seventh and eighth rotary joints have the same construction as the fourth, fifth, or sixth rotary joints. For this reason, in FIG. 10 and FIG. 11, elements similar to the elements of these rotary joints are assigned with the same reference numerals as the reference numerals used in FIG. 7, 8 or 9, and detail descriptions thereof are omitted.

In the seventh rotary joint, heat is transferred from the outer peripheral surface coating layer 10d, where heat is generated as a result of the relative rotational sliding contact with the annular sealing members 51, to the inner peripheral surface coating layer 10f through the non-sealing end face coating layer 10e, and surfaces except for the sealing end faces 31a of the terminal rotary seal rings 31B (non-sealing end faces and inner/outer peripheral surfaces of the seal ring base material) are heated to the same or substantially the same temperature. Therefore, the temperature difference is reduced between the sealing end faces 31a of the terminal rotary seal rings 31B, where heat is generated as a result of the relative rotational sliding contact with the stationary seal rings 32, and the surface areas of the seal ring material other than the those portions. In other words, the surface of the seal ring base material is brought to a substantially uniform temperature and the development of thermal strain on the sealing end faces 31a is prevented as much as possible. In addition, in the eighth rotary joint, wear and heat generation due to the relative rotational sliding contact of the sealing end faces 31a of the terminal rotary seal rings 31B with the sealing end faces 32a of the counterpart seal rings 32 is minimized as much as possible. Furthermore, as a result of use of the series of coating layers 10d, 10e and 10g, the two end faces 31a, 31b and the outer peripheral surfaces of seal ring base material of the terminal rotary seal rings 31B are brought to a uniform temperature and the development of thermal strain on the sealing end faces 31a is minimized even more effectively. In the seventh and eighth rotary joints, the above-described effects are displayed in more a pronounced manner with the coating layers 10d, 10e, 10f and 10g made from diamond.

It should be noted that the configuration of the invention is not limited to the above-described embodiments and can be suitably improved and modified without departing from the basic principles of the present invention.

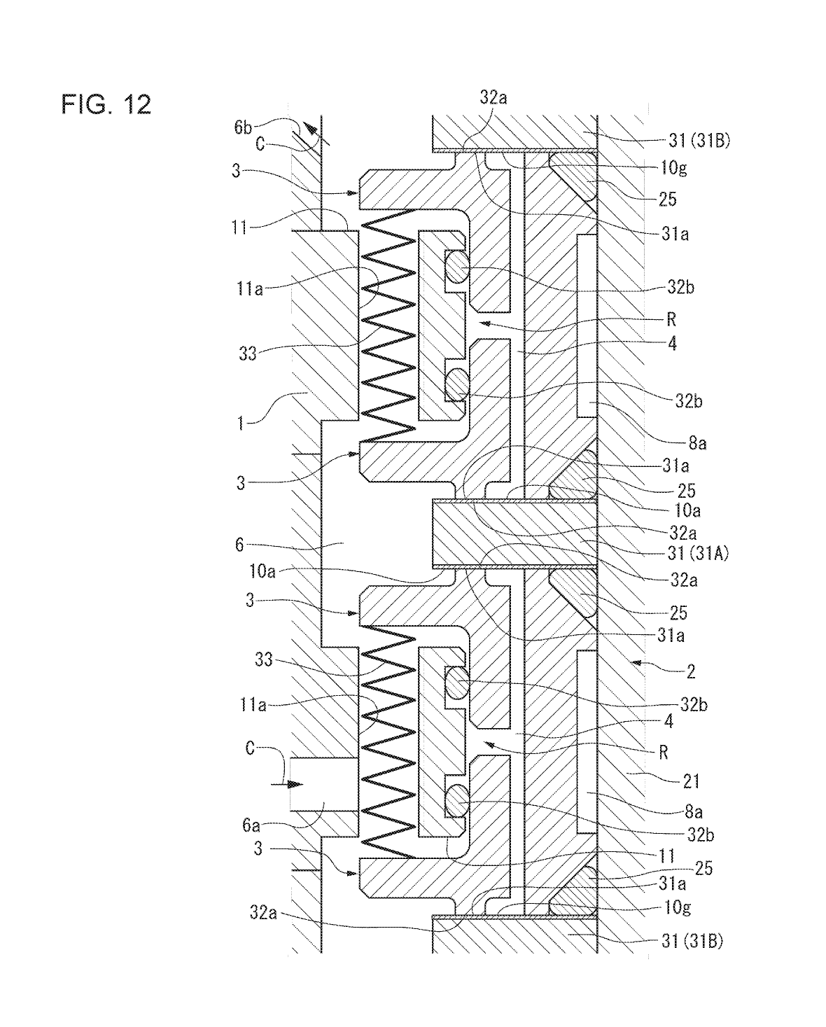

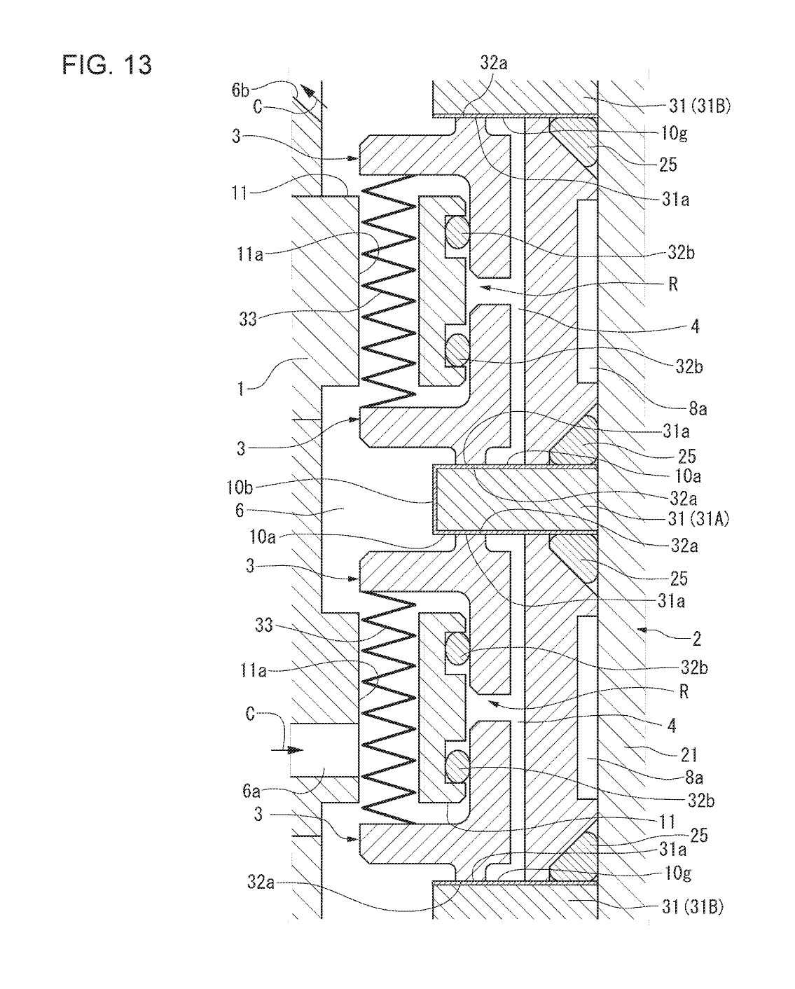

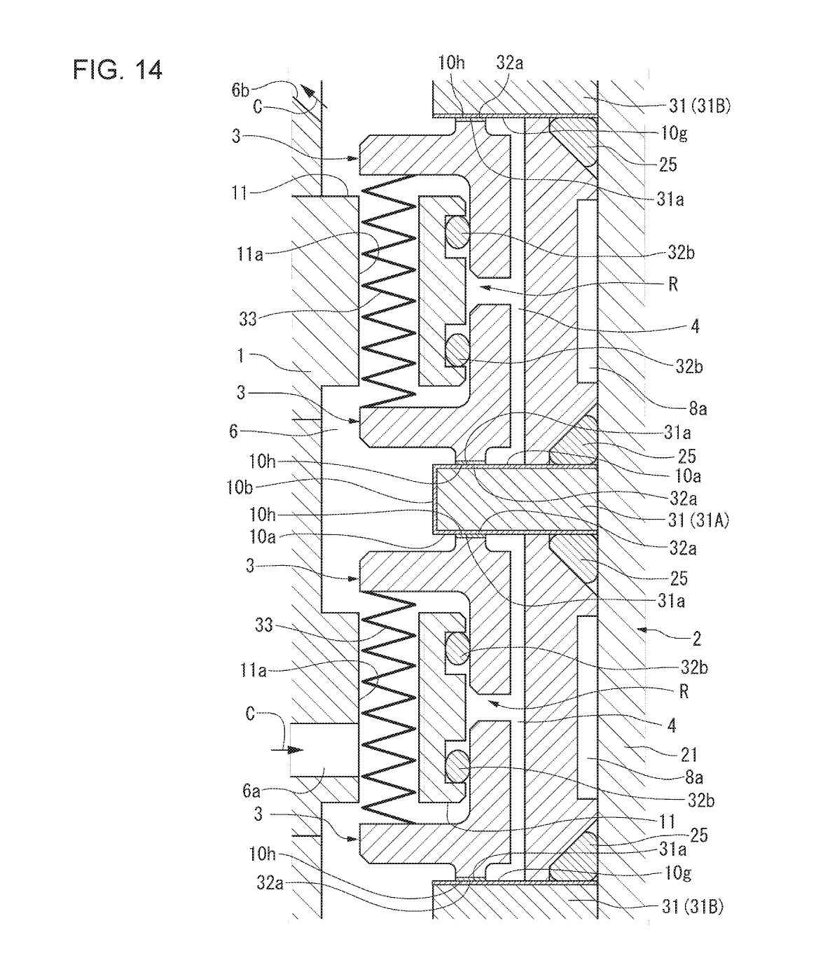

For example, in the multi-channel rotary joint of the present invention, coating layers can be formed on the sealing end faces 31a, 32a of all the seal rings 31, 32, all the rotary seal rings 31, or all the stationary seal rings 32 from a material with a higher heat transfer coefficient and hardness and a lower coefficient of friction (diamond being most suitable) compared to the material constituting the seal ring base material of the seal rings 31, 32. Examples are illustrated in FIGS. 12-14. FIG. 12 is a cross-sectional view of an essential portion corresponding to FIG. 3 and illustrates an example in which diamond coating layers 10g are formed on the sealing end faces 31a of the rotary seal rings 31 (terminal rotary seal rings 31B) in addition to the double-duty rotary seal ring 31A in the first rotary joint. FIG. 13 is a cross-sectional view of an essential portion corresponding to FIG. 5 and illustrates an example in which diamond coating layers 10g are formed on the sealing end faces 31a of the rotary seal rings 31 (terminal rotary seal rings 31B) in addition to the double-duty rotary seal ring 31A in the second rotary joint. FIG. 14 is a cross-sectional view of an essential portion corresponding to FIG. 5 and illustrates an example in which diamond coating layers 10g, 10h are formed on the sealing end faces 31a, 32a of the stationary seal rings 32 and rotary seal rings 31 (terminal rotary seal rings 31B) in addition to the double-duty rotary seal ring 31A in the second rotary joint (thus being an example in which diamond coating layers 10a, 10g, and 10h are formed on the sealing end faces 31a, 32a of all the seal rings 31, 32).

In this manner, wear, heat generation, and thermal strain produced as a result of the relative rotational sliding contact between the rotary seal rings 31 and counterpart seal rings 32 are prevented as much as possible, thereby enabling adequate mechanical sealing capabilities of all the mechanical seals 3 . . . that form part of the multi-channel rotary joint and permitting adequate flow of fluids F along the channels R for an extended period of time. In particular, as shown in FIG. 14, such effects are provided in a more pronounced manner as a result of forming of the diamond coating layer 10h on the sealing end faces 32a of all the stationary seal rings 32 in addition to the sealing end faces 31a of all the rotary seal rings 31, including the double-duty rotary seal ring 31A.

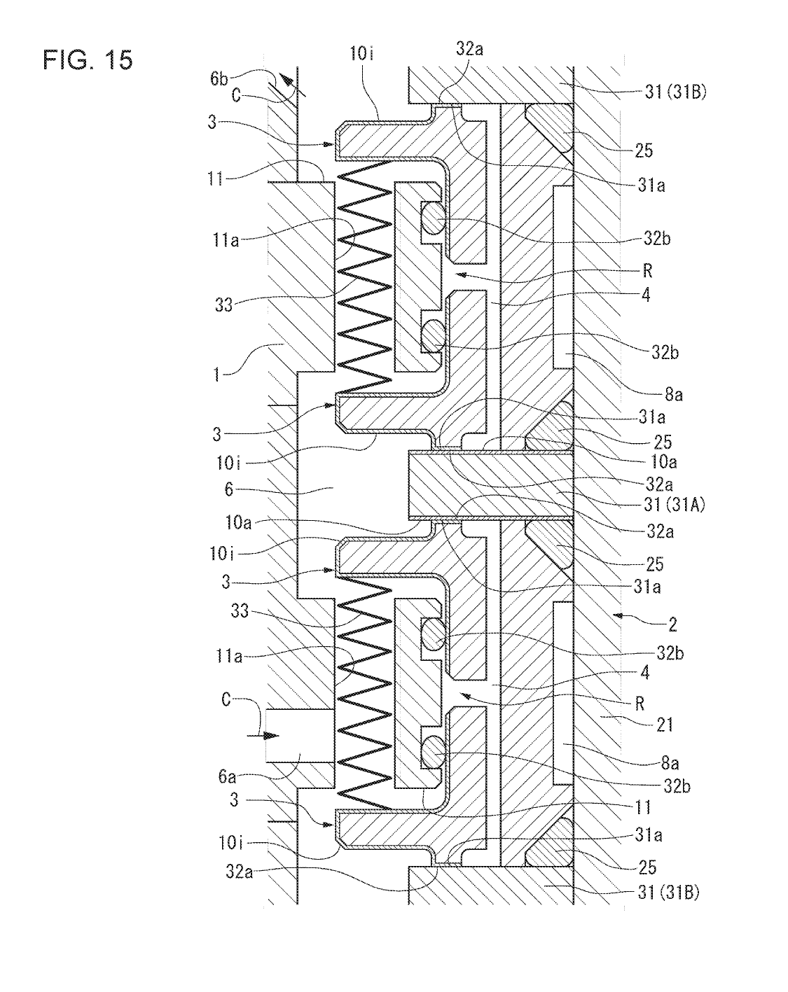

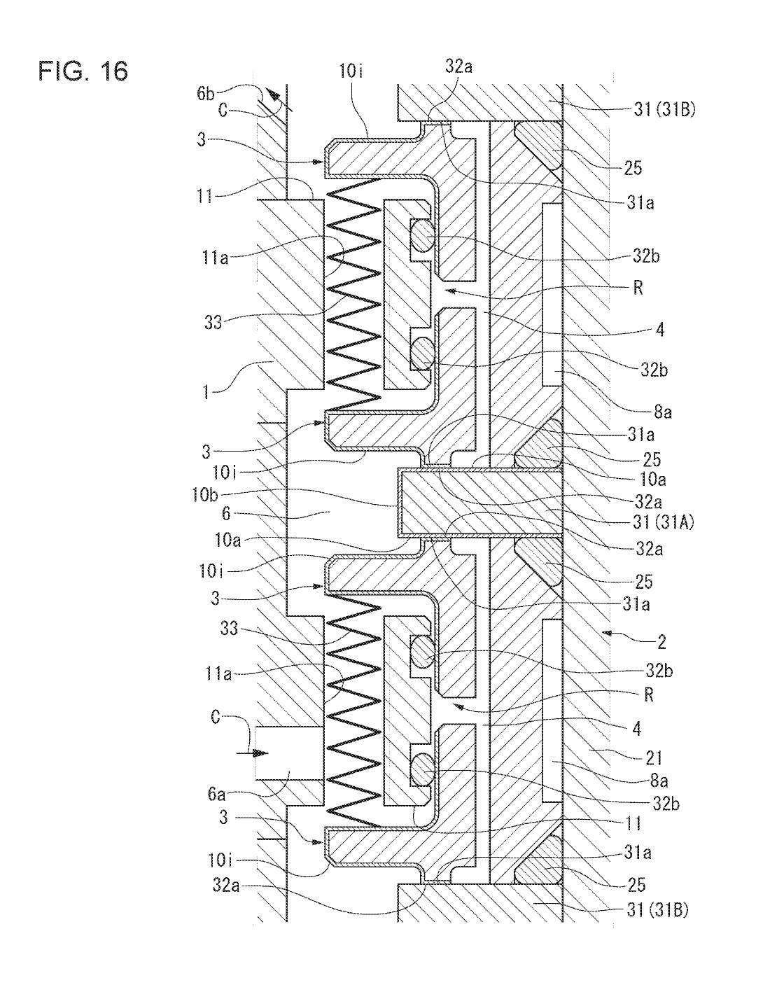

In addition, in the multi-channel rotary joint of the present invention, coating layers made from a material (diamond being most suitable) with a higher heat transfer coefficient and hardness and a lower coefficient of friction compared to the material constituting the seal ring base material of the stationary seal rings 32 can be formed continuously in the areas on the surface of the stationary seal rings 32 that are in contact with cooling fluid C, including the sealing end faces 32a (hereinafter referred to as “cooling fluid contact areas”). Examples are illustrated in FIG. 15 and FIG. 16.

FIG. 15 is a cross-sectional view of an essential portion corresponding to FIG. 3 and illustrates an example in which a diamond coating layer 10i is formed in the cooling fluid contact areas of the stationary seal ring 32 in the first rotary joint. FIG. 16 is a cross-sectional view of an essential portion corresponding to FIG. 5 and illustrates an example in which a diamond coating layer 10i is formed in the cooling fluid contact areas of the stationary seal rings 32 in the second rotary joint. With the diamond coating layers 10i formed in this way in all the cooling fluid contact areas of the stationary seal rings 32, the stationary seal rings 32 are cooled by cooling fluid C, and the wear and heat generated in the areas of relative rotational sliding contact with the counterpart seal rings 31 are prevented in a more efficient manner. Consequently, the wear, heat generation, and thermal strain produced as a result of the relative rotational sliding contact with the sealing end faces 31a, 32a in the mechanical seals 3 can be prevented as much as possible, and adequate mechanical sealing capabilities can be provided for an extended period of time.

Incidentally, ultrapure or pure water, or fluids averse to metal ion elution, are used in CMP apparatuses and other rotary devices used in the semiconductor field, and these fluids need to flow through the rotary joint without creating contamination; and thus it has been proposed to make the mechanical seal components in contact with the fluid flowing through the channels of the rotary joint from silicon carbide or plastics that are unlikely to generate particles or metal ions. For example, as disclosed in Japanese Patent Application Laid-Open (Kokai) No. 2003-200344, silicon carbide is used to make seal rings, and plastics, such as engineering plastics, are used to make the rotary joint components other than the seal rings that are in contact with the fluid flowing through the channels. However, in such a rotary joint, the seal rings cannot be made from cemented carbide and the like, which may be prone to metal ion elution, and the range of seal ring materials available for selection is severely limited. In addition, if the seal rings are made from silicon carbide, then there is a risk that erosion and corrosion could develop in such seal rings upon contact with the fluid flowing through the rotary joint if the fluid is ultrapure or pure water.

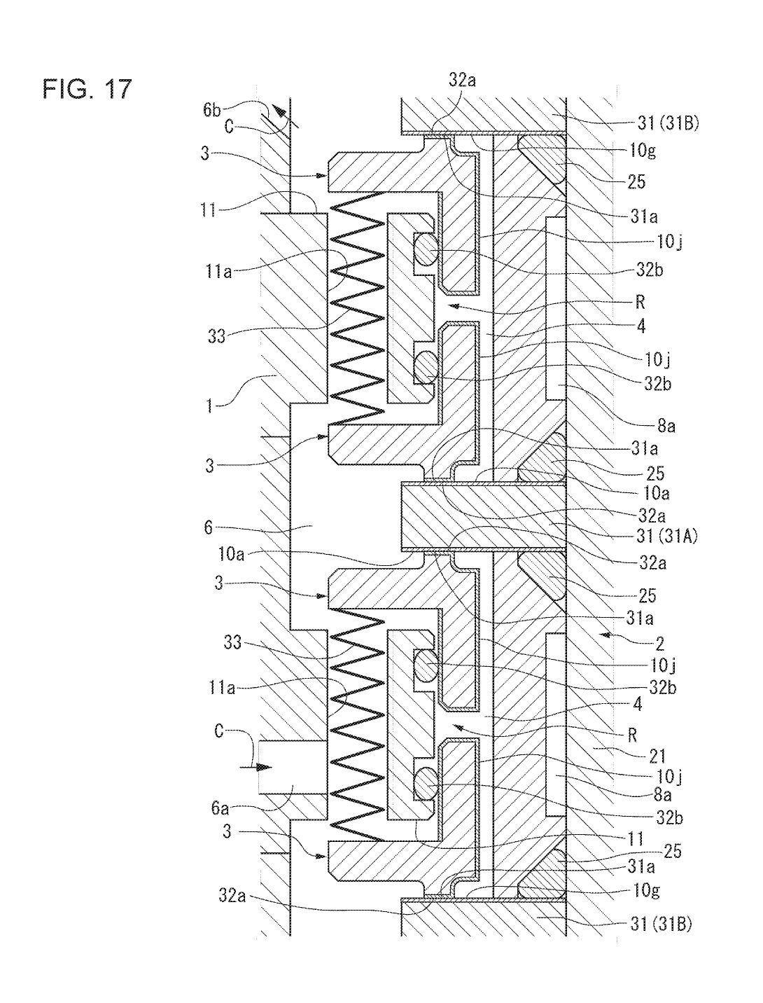

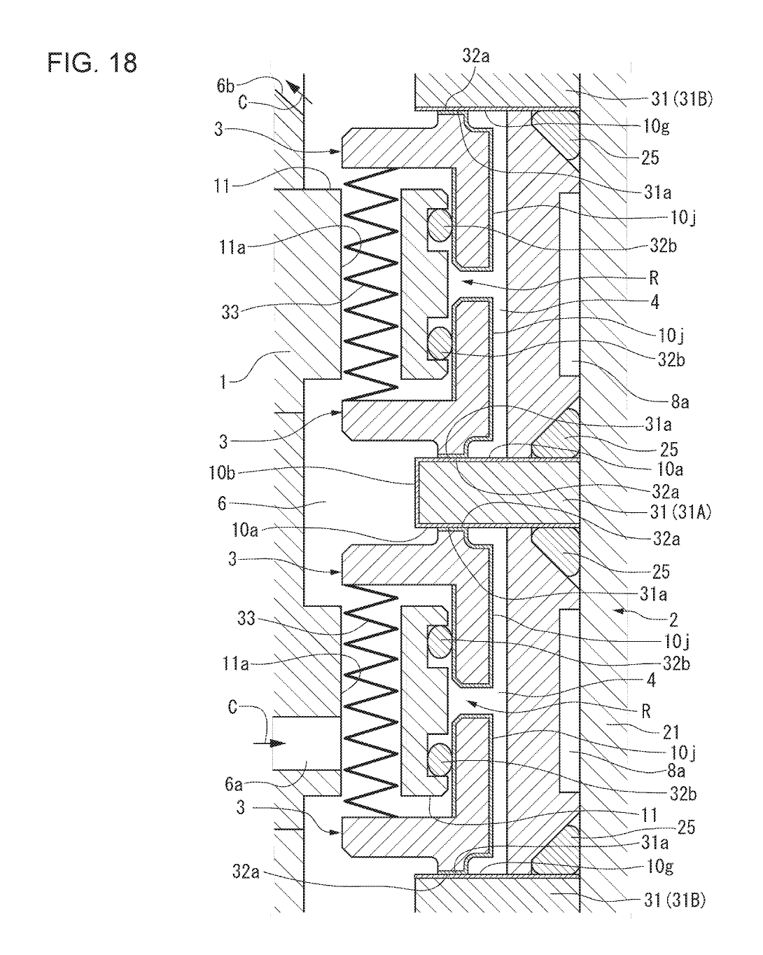

In such a case, in the multi-channel rotary joint of the present invention, coating layers made from diamond, which possesses electrical insulating properties and is chemically and physically stable, are formed continuously on those surface areas of the seal rings 31, 32 that are in contact with fluid F flowing through channels R (hereinafter referred to as “flowing fluid contact areas”). Examples are illustrated in FIGS. 17 and 18. FIG. 17 is a cross-sectional view of an essential portion corresponding to FIG. 3 and illustrates an example in which the flowing fluid contact areas of the seal rings 31, 32 are covered with diamond coating layers 10a, 10g, and 10j in the first rotary joint. FIG. 18 is a cross-sectional view of an essential portion corresponding to FIG. 5 and illustrates an example in which the flowing fluid contact areas of the seal rings 31, 32 are covered with diamond coating layers 10a, 10g, and 10j in the second rotary joint. It should be noted that, in the examples of FIGS. 17 and 18, only the end faces (sealing end faces) 31a constitute the surface areas (flowing fluid contact areas) of the rotary seal rings 31 that are in contact with fluid F.

With the flowing fluid contact areas of the seal rings 31, 32 covered in this manner with the diamond coating layers 10a, 10g, and 10j, the seal rings 31, 32 can be made from cemented carbide, etc., which is prone to metal ion elution, as well as silicon carbide, etc., which is prone to erosion and corrosion on contact with ultrapure and pure water, and there are no limitations on the range of materials used to make the seal rings 31, 32. In this case, the surfaces and areas of the rotary joint components, which are in contact with fluid F that form part of channels R and are other than the seal rings 31, 32, are coated with or formed from plastics (for example, fluororesins or polyether ether ketones (PEEK), polyphenylene sulfide (PPS), and other engineering plastics). With such a configuration used, the above-described problems do not arise when fluid F flowing through channels R is ultrapure or pure water, or when it is a fluid averse to metal ion elution.

In addition, even if fluid F flowing through channels R is not ultrapure or pure water or a fluid averse to metal ion elution, increased cooling effects can be expected from such fluid F if the fluid F has superior cooling capability compared to cooling fluid C (for example, when fluid F is a liquid whose temperature is lower than that of cooling C, etc.). For this reason, it is preferable to form a coating layer 10j, such as the one illustrated in FIG. 17 or FIG. 18, in the surface areas (flowing fluid contact areas) of the stationary seal rings 32 that are in contact with fluid F in the stationary seal rings 32. It should be noted that if the two fluids in contact with the inner and outer peripheral surfaces of the stationary seal rings 32 are heterogeneous fluids (if either one of fluid F flowing through channels R and cooling fluid C in the cooling fluid space 6 is a liquid, and the other one is a gas (e.g., if gases such as atmospheric air or inert nitrogen gas are supplied to the cooling fluid space 6)), then it would be preferable to form the coating layer 10i of FIG. 15 or FIG. 16, or coating layer 10j illustrated in FIG. 17 or FIG. 18, in the areas on the surface of the stationary seal rings 32 that are in contact with the fluid which is a liquid, because a liquid is superior to a gas in terms of cooling capabilities even if the temperature of the two fluids C, F is the same or substantially the same.

In addition, the present invention is not limited to vertical-type multi-channel rotary joints, in which the rotational axis of the two bodies 1, 2 extends in the vertical direction, as described above. The resent invention is suitably applicable to a horizontal-type multi-channel rotary joint as well, in which the rotational axis extends in the horizontal direction. In addition, the present invention is not limited to multi-channel rotary joints that have two channels R, R, as described above, and it is suitably applicable to multi-channel rotary joints that have three or more channels R . . . . Furthermore, in the multi-channel rotary joint of the present invention, the number of the double-duty rotary seal rings 31A is unlimited and arbitrary. For example, three or more mechanical seal units made up of a pair of mechanical seals 3, 3, which have a double-seal arrangement with stationary seal rings 32, 32 located between two rotary seal rings 31, 31, can be arranged in a column in the axial direction and three or more channels R . . . can be formed therein. In such structures, with the exception of the mechanical seals 3, 3 at both ends of the mechanical seal group 3 . . . , a double-duty rotary seal ring 31A can be used as the rotary seal ring 31 for each mechanical seal 3 and as the rotary seal ring 31 for the mechanical seal 3 adjacent thereto. In other words, the rotary seal rings 31 of all the mechanical seals 3, with the exception of the mechanical seals 3, 3 at both ends of the mechanical seal group 3 . . . , can be used as double-duty rotary seal rings 31A.

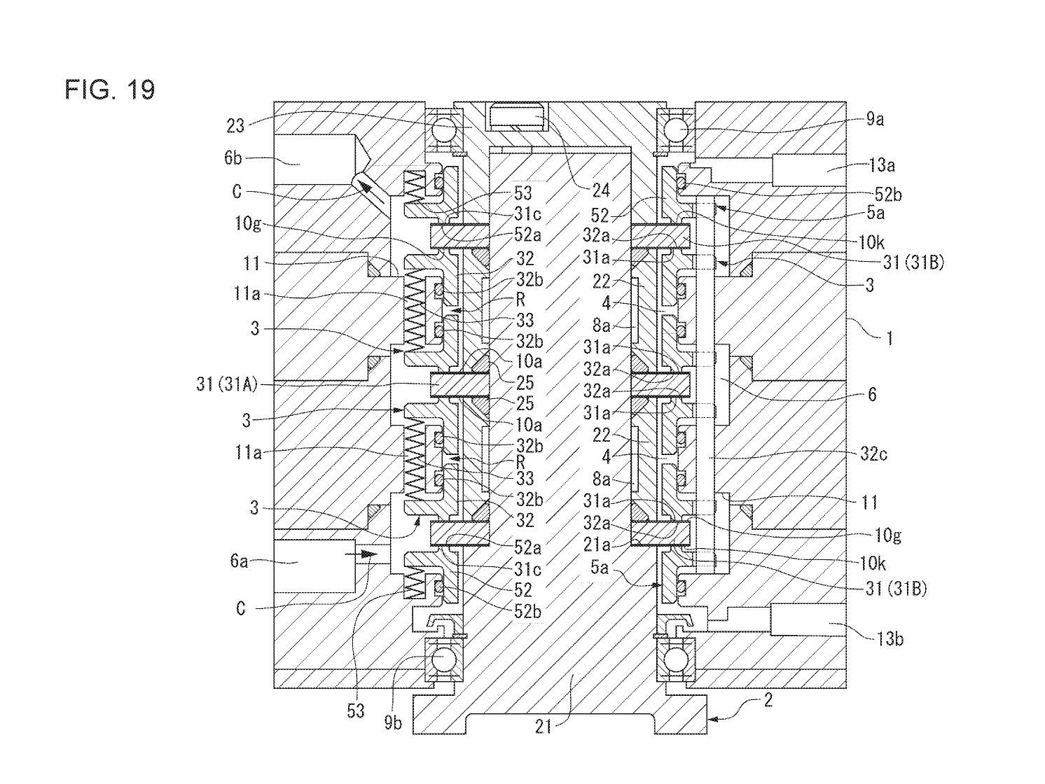

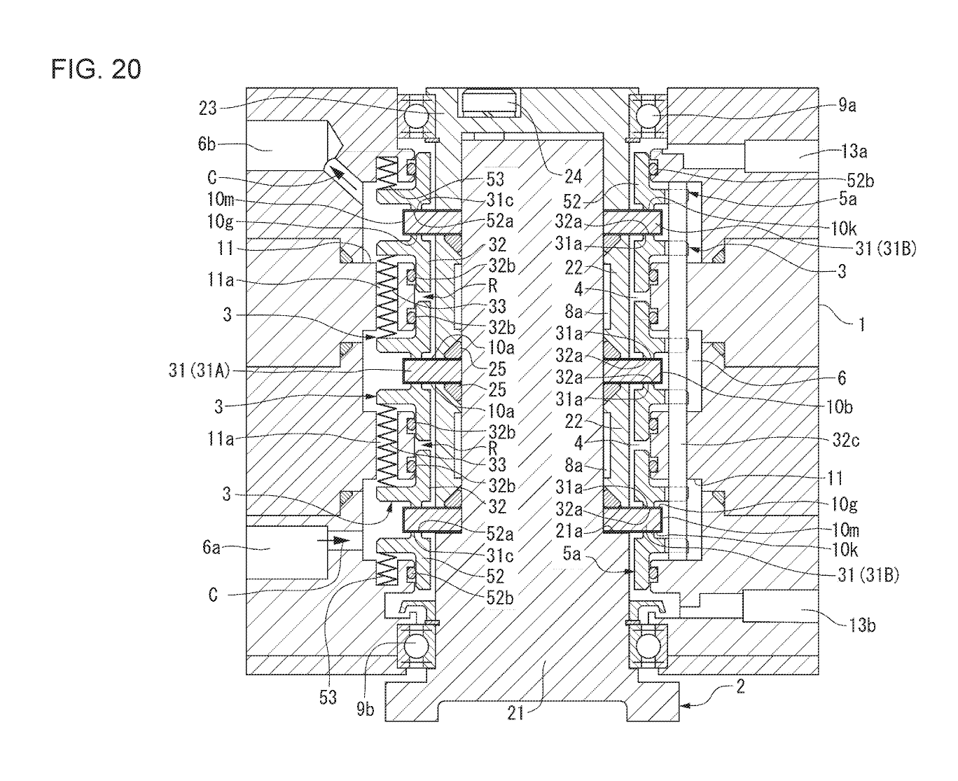

In addition, in the multi-channel rotary joint of the present invention, the oil seals 5 can be replaced with mechanical seals. Examples are illustrated in FIGS. 19 and 20. FIG. 19 is a cross-sectional view illustrating an example in which mechanical seals 5a intended for the cooling fluid space are used instead of the oil seals 5 in a first rotary joint, and FIG. 20 is a cross-sectional view in which the same is done in a second rotary joint. In the multi-channel rotary joint of the present inventions illustrated in FIG. 19 and FIG. 20, a pair of mechanical seals 5a, 5a intended for the cooling fluid space are provided so that the mechanical seals 5a are on both sides of the mechanical seal group 3 . . . that forms channels R . . . , and a cooling fluid space 6, which is a space sealed by the two mechanical seals 5a, 5a intended for the cooling fluid space and to which a cooling fluid C is cyclically supplied, is formed between the opposed peripheral surfaces of the two bodies 1, 2. In these examples, in the same manner as described above, a fluid such as room temperature water is used as cooling fluid C.

As shown in FIG. 19 or FIG. 20, each mechanical seal 5a intended for the cooling fluid space has the same construction as the mechanical seals 3. The end faces on the side opposite the sealing end faces 31a in the rotary seal ring 31 (terminal rotary seal ring 31B) of the mechanical seals 3 intended for channel formation located at the ends of the mechanical seal group 3 . . . are constituted as sealing end faces 31c of the mechanical seal 5 intended for the cooling fluid space, and this terminal rotary seal ring 31B does double duty as the rotary seal ring for the mechanical seal 5 intended for the cooling fluid space. In other words, as shown in FIG. 19 or FIG. 20, each mechanical seal 5a intended for the cooling fluid space is provided with a terminal rotary seal ring 31B, which is secured to the rotary shaft body 2, stationary seal ring 52, which is supported on the housing body 1 so as to be movable in the axial direction relative thereto, and a spring 53, which press-contacts the stationary seal ring 52 to the terminal rotary seal ring 31B. The mechanical seals 5a are adapted to use the relative rotational sliding contact action of the sealing end faces 31c, 52a (i.e., the opposed end faces of the two seal rings 31B, 52) to seal the cooling fluid space 6, which is the outer peripheral region of the area of relative rotational sliding contact, and a bearing placement space, which is the inner peripheral region thereof.

With use of the mechanical seals 5a that is intended for the cooling fluid instead of the oil seals 5 in this manner, the cooling fluid space 6 is sealed even more reliably than when using the oil seals 5, and the pressure of cooling fluid C supplied to the cooling fluid space 6 can be increased even more.

In the structure in which the mechanical seals 5a that are intended for the cooling fluid and used instead of the oil seals 5 is employed, as shown in FIG. 19 or FIG. 20, it is preferable to form coating layers 10g, 10k made from a material (diamond being most appropriate) with a higher heat transfer coefficient and hardness and a lower coefficient of friction than those of the material constituting the seal ring base material of the rotary seal ring 31B on the two end faces 31a, 31c of the terminal rotary seal ring 31B of each mechanical seal 5a intended for the cooling fluid space. In other words, it is preferable to use the above-described double-duty rotary seal ring as the rotary seal ring 31 for all the mechanical seals that form part of the multi-channel rotary joint (mechanical seals 3 intended for channel formation and mechanical seals 5a intended for the cooling fluid space) and form diamond coating layers 10a, 10g, and 10k on its two end faces (sealing end faces). Furthermore, as illustrated in FIG. 20, it is preferable to form a diamond coating layer 10m that is continuous to the diamond coating layers 10g, 10k on the two sealing end faces 31a, 31c on either of the inner and outer peripheral surfaces of each terminal rotary seal ring 31B.

In addition, even in the structure that the oil seals 5 are replaced with the mechanical seals 5a as described above, it is preferable to form coating layers similar to the coating layers 10h, 10i, and 10j illustrated in FIGS. 14-17 on the stationary seal rings 32, 52 of all the mechanical seals 3, 5a. For example, it is preferable to form a diamond coating layer similar to the coating layer 10i of FIG. 15 or FIG. 16 in the area of contact (including the sealing end face 52a) with cooling fluid C supplied to the cooling fluid space 6 on the surface of the stationary seal ring 52 of the mechanical seal 5a intended for the cooling fluid space. In addition, it is further preferable to form a diamond coating layer similar to the coating layer 10j of FIG. 17 or FIG. 19 in the area of contact (including the sealing end face 52a) with fluid F flowing through channels R on the surface of the stationary seal ring 52 of the mechanical seal 5a intended for the cooling fluid space.

### REFERENCE SIGNS LIST

1 Housing Body
2 Rotary Shaft Body
3 Mechanical Seal
4 Passage Connection Space
5 Oil Seal
5a Mechanical Seal Intended for Cooling Fluid Space
6 Cooling Fluid Space
6a Cooling Fluid Supply Passage
6b Cooling Fluid Discharge Passage
7 Fluid Passage
8 Fluid Passage
8a Header Space
8b Cross-Over Hole
8c Fluid Passage Main Body
9a Bearing
9b Bearing
10a Coating Layer
10b Coating Layer
10c Coating Layer
10d Coating Layer
10e Coating Layer
10f Coating Layer
10g Coating Layer
10h Coating Layer
10i Coating Layer
10j Coating Layer
10k Coating Layer
10m Coating Layer
11 Annular Wall
11a Cross-Over Hole
13a Drain
13b Drain
21 Shaft Main Body
21a Bearing-Receiving Portion
22 Sleeve
23 Bearing Seat
24 Bolt
25 O-Ring
31 Rotary seal ring
31A Rotary seal ring (Double-Duty Rotary seal ring)
31B Rotary seal ring (Terminal Rotary seal ring)
31a Sealing End Face of Rotary seal ring
31b Non-Sealing End Face of Rotary seal ring
31c Sealing End Face of Rotary seal ring
32 Stationary seal ring
32a Sealing End Face of Stationary seal ring
32b O-Ring
32c Drive Pin
33 Spring
51 Annular Sealing Member
51a Reinforcing Bracket
51b Garter Spring
52 Stationary seal ring
52a Sealing End Face of Stationary seal ring
C Cooling Fluid
F Fluid
R Channel

1. A multi-channel rotary joint in which,
between opposed peripheral surfaces of a tubular housing body and a rotary shaft body coupled thereto in a manner to make a relative rotation, four or more mechanical seals are provided,
which are adapted to effect sealing using relative rotational sliding contact action of sealing end faces that are opposed end faces of stationary seal rings provided on said housing body and rotary seal rings provided on the rotary shaft body, and
which are arranged in a columnar configuration in a direction of a rotational axis of said two bodies,
thus forming multiple passage connection spaces sealed by adjacent mechanical seals,
said two bodies are formed therein fluid passages which are in communication through the passage connection spaces, and,
a single rotary seal ring, both end faces of which are sealing end faces, is provided so as to do double duty as a rotary seal ring for at least one mechanical seal and as a rotary seal ring for a mechanical seal adjacent thereto, wherein:
coating layers made from a material with a higher heat transfer coefficient and hardness compared to a material of said rotary seal ring are formed on both end faces of said double-duty rotary seal ring.

2. The multi-channel rotary joint according to claim 1, wherein
coating layers made from a material with a higher heat transfer coefficient and hardness compared to the material of said double-duty rotary seal ring are formed continuously on both end faces and either one of inner and outer peripheral surfaces of said rotary seal ring.

3. The multi-channel rotary joint according to claim 1, wherein
a pair of oil seals are provided on both sides of a mechanical seal group disposed in a columnar configuration in the direction of the rotational axis of said two bodies, and
a cooling fluid space, which is a space to which a cooling fluid is cyclically supplied and which is sealed by said two oil seals, is formed between said opposed peripheral surfaces of said two bodies.

4. The multi-channel rotary joint according to claim 1, wherein
a pair of mechanical seals that are intended for a cooling fluid space and have a same construction as said mechanical seals are provided on both sides of a mechanical seal group provided in a columnar configuration in the direction of the rotational axis of said two bodies, and
a cooling fluid space, which is a space to which a cooling fluid is cyclically supplied and which is sealed by two mechanical seals intended for the cooling fluid space, is provided between the opposed peripheral surfaces of said two bodies.

5. The multi-channel rotary joint according to claim 4, wherein
a single rotary seal ring, both end faces of which are sealing end faces, is provided so as to do double duty as a rotary seal ring for each mechanical seal intended for the cooling fluid space and as a rotary seal ring for the mechanical seal adjacent thereto, and
a coating layer made of a material with a higher heat transfer coefficient and hardness than the material of said rotary seal ring is formed on both end faces of said rotary seal ring.

6. The multi-channel rotary joint according to claim 4, wherein
a single rotary seal ring, both end faces of which are sealing end faces, is provided so as to do double duty as a rotary seal ring for each mechanical seal intended for the cooling fluid space and as the rotary seal ring of the mechanical seal adjacent thereto, and
coating layers made of a material with a higher heat transfer coefficient and hardness than the material of said rotary seal ring are formed continuously on both end faces and either one of the inner and outer peripheral surfaces of said rotary seal ring.

7. The multi-channel rotary joint according to claim 1, wherein
a radial face width of said sealing end faces of said stationary seal rings that are in relative rotational sliding contact with said double-duty rotary seal ring is configured to be smaller than a radial face width of said sealing end faces of said rotary seal ring.

8. The multi-channel rotary joint according to claim 1, wherein
coating layers made from a material with a higher heat transfer coefficient and hardness compared to the material of said seal ring are formed on sealing end faces of all of said seal rings, all of said rotary seal rings, or all of said stationary seal rings.

9. The multi-channel rotary joint according to claim 3, wherein
each of said oil seals is comprised of rotary seal ring located at end of the seal ring group and an annular sealing member of elastic material secured to said housing body and applying pressure to the outer peripheral surface of said rotary seal ring, and
coating layers made from a material with a higher heat transfer coefficient and hardness compared to the material of said rotary seal rings are formed on outer peripheral surface and at least one of two end faces of said rotary seal ring that form part of each oil seal.

10. The multi-channel rotary joint according to claim 9, wherein
passages used for supplying and discharging a cooling fluid, through which a cooling fluid is cyclically supplied to the cooling fluid space, are formed in said housing body.

11. The multi-channel rotary joint according to claim 10, wherein
the rotational axis of said two bodies extends in a vertical direction.

12. The multi-channel rotary joint according to claim 9, wherein,
in an event that fluid flowing through a series of channels formed by connecting the fluid passages of said two bodies through said passage connection spaces is ultrapure or pure water or is a fluid averse to metal ion elution, said coating layers are formed continuously on surfaces in contact with said fluid in the seal rings, including on sealing end faces of said seal rings, and
surfaces or areas in contact with said fluid in members, which are other than said seal rings and form part of said channels, are made from plastics.

13. The multi-channel rotary joint according to claim 1, wherein said coating layer is made from diamond.

14. The multi-channel rotary joint according to claim 5, wherein said coating layer is made from diamond.

15. The multi-channel rotary joint according to claim 6, wherein said coating layers are made from diamond.

16. The multi-channel rotary joint according to claim 7, wherein said coating layers are made from diamond.

17. The multi-channel rotary joint according to claim 8, wherein said coating layers are made from diamond.

18. The multi-channel rotary joint according to claim 9, wherein said coating layers are made from diamond.

19. The multi-channel rotary joint according to claim 12, wherein said coating layers are made from diamond.
